(19) United States
(12) Patent Application Publication
(10) Pub. No.: US 2011/0186006 A1
(43) Pub. Date: Aug. 4, 2011

(54) METHOD FOR PROVIDING A THERMO-DYNAMIC CYCLE OF A COMBUSTION ENGINE, IN PARTICULAR OF A ROTARY TYPE WITH A DOUBLE CENTER OF ROTATION

(76) Inventor: Ruggero Libralato, Belluno (IT)

(21) Appl. No.: 13/119,785

(22) PCT Filed: Sep. 21, 2009
(86) PCT No.: PCT/EP2009/006807

§ 371 Date: Mar. 18, 2011

(30) Foreign Application Priority Data
Sep. 19, 2008 (IT) BL2008A14

(51) Int. Cl. F02B 53/00

(52) U.S. Cl. 123/242

(57) ABSTRACT

The invention regards to a method for providing a thermo-dynamic cycle of the internal combustion engine (1), with double center of rotation, for better exploitation of the propulsion in the phase of combustion from the mixture gas, characterized from the fact that the same phase of combustion and expansion, beyond that of to produce the greatest power request for the entire combustion, allows to contemporarily activate the succession at its channels, therefore finishing the expected inlet stroke of compression of the air for the successive cycle of combustion, particularly optimising the inlet stroke, that is realized in different times and channels, to guarantee the necessary depression for the acquisition of the greatest volume of air, to then meet in the compression chamber, determining the especially most favourable compression ratio.

### TECHNICAL FIELD

The present innovation pertains to the realization of an optimised thermodynamic cycle for the better usage of a combustion force, whose cycle is particularly feasible in a rotary combustion engine with two centers of rotation.

### BACKGROUND ART

The current endothermic motors are characterized by pistons with linear motion across the cylindrical combustion chamber are only able to inspire at most the volume of air that is available, which is equal to the maximum expansion of the combustion gas, thus resulting in only a partial use of the air with respect to the volume of the gas in the phase of expansion, and therefore only partial use of the subsequent combustion and expansion.

Furthermore the necessary transformation of alternative motion of the pistons to rotary movement by the motor, determines an ulterior lowering of the available force, so determining remarkable dimensions and consequently oversizing of the motor with respect to the minimum volume, required in the useful phase of expansion, just for being able to transfer as best possible the linear movement of the piston.

As mentioned before the oversizing and clutter associated with piston engines results in added weight to the system, which furthermore reduces the efficiency of the system.

In order to overcome these efficiency problems, multiple solutions have been devised with the goal of simplifying the structure of the combustion engine, and in particular creating diverse solutions of motors with rotating wheels, which have proved to be of limited success due to the numerous problems associated with the proper fabrication and functioning of the system.

In the field of these rotary engine Italian patents No. 1.234.671, No. 1.234.679 and No. 1.234.406 from 1991 on behalf of Libralato, which are innovatively based on a rod that rotates two centers of rotation and a rotor, which consists of two elements that are semi cylindrical and are connected between them from a gate, which also functions as a hinge, the elements with their rotation on their respective axes form between the rod variable volumes that can be used for phases of aspiration, compression, ignition, and expansion, which are all foreseen in a normal thermodynamic cycle.

Further improvements to these solutions have been realized by Italian patent No. 1.332.091 from 2002, and extended with patent application WO 2004/020791 A1 and with deposited patents no. BL2004A06 and BL2004A07 dating from 2004, under Libralato name, which have been greatly improved and made more function the initial design of the combustion engine with two centers of rotation.

Some aspects of the embodiment being basis of present invention and proposed in WO 2004/020791 A1 are described in the following referring to some elements shown in different enclosed figures, and in particular with reference to FIGS. 21 to 33 of present invention, as far as the embodiments are comparable.

An endothermic engine 1 is fundamentally formed by a stator A that is in turn formed by a central body, by a head cover wail A2 and by a back cover wall A3, while its rotor, in turn, is formed by a rotating compression element B2, by a rotating expansion element B1 and by the slider or linear hinging and linking rotating element B3.

The central body of the stator A is fundamentally formed by a pair of cylindrical hollows or chambers 1*, 2, passing and intersecting each other, said chambers 1*, 2 being aligned with vertical axes parallel and spaced to each other by a distance, and with a common horizontal axis. The intersections between the vertical axis and the horizontal axis determine longitudinal axes, which are orthogonal to these vertical and horizontal axes, are parallel to each other, and concentric to respective cylindrical walls of the chambers 1*, 2. The chambers 1*, 2 are contained in a substantially double cylinder-shaped center annulus 4 provided with external cooling fins.

In the upper part of the central body of the stator A, in a proper position of an upper part of the annulus 4, a hole with an inner thread is provided for the housing of a spark plug C or injector.

The hole being allowed to communicate with an open compartment or combustion chamber forming a fifth room 5C arranged between the hole and the chambers 1*, 2. Preferably, the fifth room 5C is shaped with a substantially rounded surface and opens toward the chambers 1*, 2.

The fifth room 5C is placed substantially in an upper position between the two vertical axes.

A chamber links and connects the fifth room 5C with the upper part of the chamber 2.

In the lower part of the central body of the stator A, in a proper position of a lower part of the annulus 4, a cylindrical exhaust port 10 is provided. The exhaust port 10 is arranged at a side face of the annulus 4 and is connected with flares forming an inside opening 11 that are open along the inner surface of the cylindrical chamber 1*. The exhaust port 10 is arranged with an inclination e.g. equal to about 20° with respect to the vertical axis of the chamber 1*.

The central body A1 is completed by the presence of a series of holes 12, into which plugs and/or screws are applied, for steadily fixing the central body Al to the opposing head and back covers or sides A2*, A3*.

The sides A2*, A3* are substantially formed by flat bodies externally finned, and are provided with opposing flat surfaces 20 and 40, respectively. The outer perimeter of the sides A2*, A3* corresponds to the outer perimeter of the center annulus 4 of the central body A1, to which they are steadily fixed, for example by means of screws and/or plugs passing through holes 21 and 41, respectively, that are aligned to the holes 12 presenting themselves at the side faces of the central body.

Both sides A2*, A3*, at their opposing surfaces contacting the central body A, have a cylindrical groove or chamber that is coaxial to the orthogonal axis, being thus concentric to the chamber 1* of the central body. Each of the cylindrical grooves determines, in its inner side or better axial bottom a circular surface having a circumference equal to the inner diameter of the groove. An axially raised portion or plane is provided on a part of the surface, its edge being determined partially by the inside radius of the groove and on its opposite side by a corresponding radius centered on the orthogonal axis of the chamber 1* of the central body.

A hole formed as an inside opening 25 that is preferentially tilted and provided with an inner flare, is provided on each of the raised portions of the sides A2*, A3*. The flare is placed at the lower part of the sides A2*, A3* and turns inwardly. The inside opening 25 is placed between the vertical axes of the chambers 1*, 2, constrained within a cylindrical part of the respective groove.

A cylindrical tang can project from the raised portion. The tang or support projects toward the inner side of the chamber 1* and is arranged concentrically to the axis. Further, the tang is provided with an axial hole that communicates with the respective outer surfaces of the sides A2*, A3*.

The sides A2*, A3* each further comprise a cylindrical through hole that is placed in such a position to be coaxial to the port 10 of the central body A1, and a through hole forming a further inside opening 30 shaped, as shown, as a circular segment and intended to communicate with that zone of the chamber 1* that is near the flares forming inside opening 11, which communicate with the exhaust port 10 of the central body of the stator A.

In particular, the circular segment shape of the further inside opening 30 known as such is determined by the necessity of facilitating at its best the exhaust stroke, during opening and closing thereof, regulated by the passage of particular points of the first and second rotating elements B1, B2.

After having described the main components constituting the stator A of the engine 1, the main components of the rotor B, which are to be housed in the chambers 1*, 2 of the stator A, are hereinafter described.

As already mentioned, that rotor B substantially comprises the first rotating expansion element B1 hinged by means of the slider forming a third rotating element B3 or hinging or sliding element.

The second rotating compression element B2 is housed in the chamber 2 of the stator A, and is provided to rotate around the orthogonal axis of the stator A, this being meant to achieve compression of the mixture, before firing it in the combustion chamber.

The second compression element B2 is formed by a circular segment outer surface wall 50 having a radius substantially identical to the radius of the chamber 2, and being supported by a pair of side walls that are linked on their respective outside surfaces, to a pair of rings, respectively.

Being placed outside the pair of side walls, the pair of rings presents a reciprocal distance that is equal to the width of the circular segment surface wall, which is, in turn, substantially identical to the width or depth of the central body, in the chamber 2 of which said second compression element B2 is meant to rotate.

By application of the sides A2*, A3* to the sides of the central stator A body, after introduction of the second compression element B2 into the chamber 2, a consequent theoretical contact between the outside surfaces of the pair of walls of the second compression element B2 and the inside flat and opposing surfaces of the sides A2*, A3* is reached, except for the foreseeable clearances for the application of the side tight sealing segments as already indicated in the previous Italian patent application.

By the application of the sides A2*, A3*, further, the rings of the second compression element B2 are inserted into the respective holes or cylindrical grooves 22 of the sides A2*, A3*, which have diameters corresponding thereto and being properly provided with antifriction and lubrificant means.

Within this embodiment, the second compression element B2 is allowed to rotate inside the chamber 2 of the stator A, guiding its rings within the grooves that engage them on one of the longitudinal axis of the stator A. The pair of side walls of the second compression element B2 have an end provided with hinging loops that are linked to each other by an end portion of the circular segment-shaped outside surface wall 50, and that are preferentially provided with bushes or antifriction bearings.

The first rotating expansion element B1 of the rotor B comprises a circular segment-shaped surface wall having an outer radius substantially identical to the radius of the chamber 1* of the stator A, in which chamber 1* the first rotating element B1 is housed to rotate on its axis, in order to assure tight conditions during the usable stroke of expansion.

The first expansion rotating element B1 is to be connected to the second rotating compression element B2. The circular segment wall has a width substantially identical to the width of the central body of the stator A. The circular segment wall extends over a portion of the circumference of less than 180 and is provided with side surfaces substantially plane and meant to slide on the flat surfaces of the stator sides A2* and A3*, respectively, except for interposing of proper tight packings.

Said side walls or surfaces have a depressed zone near a hub 63 through which a through hole is provided, in which two portions of a main shaft are keyed or otherwise fixed. The depressed zone allows the walls of the second compression element B2 to rotate without contacting neither of the first rotating element B1 and the walls of the stator sides A2*, A3*.

On the depressed zone, and in particular on both sides of the hub 63 of the side walls, a groove or further depression of throat 65 with limited corner width is provided.

The hub 63 is further provided with, besides the through hole able to house and steadily fix the main shaft, a radial shoulder and a radial flat surface that will be used as thrusting surfaces during the expansion stroke of the engine at issue.

The first rotating expansion element B1 is completed by the presence of a radial through hole which starts at the outer wall of the shoulder of the hub 63, and reaches the outer side of the edge or circular segment wall. The through hole has a rectangular cross section, with one of its inner surfaces aligned to the thrusting flat surface.

As already mentioned, the rotor B is completed by the presence of a slider formed by the third rotating element B3 able to connect, hinge and make the second rotating element B2 interact with the first rotating element B1 inside the stator A, so as to achieve the different strokes foreseen in the thermodynamic cycle of the engine at issue.

The slider formed by the third rotating element B3 comprises a rod or shaft having a rectangular cross section, or, in any case, a cross section substantially identical to the cross section of the through hole provided in the first rotating expansion element B1, and being provided with a T-shaped head. The width of the head is identical to the width of the circular outer surface wall of the second rotating element B2 and the circular segment surface wall of the first rotating element B1. At the same end of the rod or stem 70, but on the side opposite with respect to its longitudinal axis, a pivot is fixed, arranged parallel to the axis.

The lower end of the head has a chamber partially cylindrical surface that determines a cylindrical port concentric to the pivot and able to house the head surfaces of the loops at the side walls of the second rotating element B2. The port achieves gas tightness by means of proper tight sealing segments placed on the surface.

After having thus described the main components of the stator A and the rotor B, their assembly and interconnection procedure is hereafter summarized.

Firstly, the third rotating element B3 is linked to the second rotating element B2 upon insertion of the two sides of the pivot into the through holes of the loops of the side walls of the second rotating element B2. In this way, the pivot of the slider formed by the third rotating element B3 hinges the loops of the second rotating element B2. The head portions of the loops are thus housed in the circular port, delimited by the pivot and the cylindrical surface of the head of the third rotating element B3.

The assembly proceeds then with the insertion of the stem 70 of the third rotating element B3 into a through hole port 68 of the first rotating element B1, starting from the part of the flat surface. Since the second rotating element B2 is already linked and hinged to the pivot of the third rotating element B3, it is clear, that through the third rotating element B3, the first rotating element B1 and the second rotating element B2, besides being hinged to the pivot, are also allowed to slide linearly to each other along the stem 70 of the third rotating element B3, and so along the thrusting flat surface plane, till they reach their smallest bulk or closed condition.

Furthermore, since the second rotating element B2 is forced to rotate on its axis, being forced by its cylindrical rings supported within the grooves of the stator sides A2*, A3*, the first rotating element B1 is forced to rotate on the other axis because it is linked to the main shaft. The main shaft is supported at the axial hole seats of the stator sides A2*, A3*. Thus, a reciprocal relative rotating movement of the first and second rotating element B1, B2 is allowed by the contemporary or simultaneous translation of the third rotating element B3, that moves its hinged pivot along the axis of the through hole port, and the rotation of the second rotating element B2 on the pivot of the third rotating element B3.

This constraint among the three rotating elements B1, B2, B3 induces the second rotating element B2 to rotate on its axis, touching lightly with its outer surface wall concentrically the cylindrical wall of the stator chamber 2, so as to achieve the compression of air or a combustible mixture that may be between them and that is, anyway, unable to escape.

Such compression is assured also by means of the radial contact of tight sealing means placed on the first rotating element B1 and on the cylindrical wall of the stator chamber 1*.

Furthermore, the rotating movement of the second rotating element B2 and the consequent displacement of the third rotating element B3 are caused by the rotating movement of the first rotating element B1 that is forced to rotate on its axis, as a consequence of the blast or ignition of the combustible mixture in the combustion chamber.

The first rotating element B1, at the beginning of the combustion, presents its minimal thrust flat surface to the expanding combusting mixture, the minimal thrust flat surface being just sufficient to make it move. But with the fast development of the expansion, a force is immediately generated that forces the first rotating element B1 to turn in the only possible direction, presenting the gas thrust an increasing thrust surface, and, consequently, the expansion volume of the burned gases increases to completely obtain and use the power of the firing process.

As already mentioned, with the rotation of the first rotating element B1 and with the constraint of the third rotating element B3 that can only slide inside its guiding through hole and that has to drag the hinged second rotating element B2, and with the constraints of the rotation axes XZ and YZ, a translation of the third rotating element B3 is achieved, whereby a contemporary rotation and divergation between the first and second rotating elements B1 and B2 rotating on their respective own axes XZ and YZ and a consequent series of strokes of expansion and compression of the combustible mixture inside the chambers 1*, 2 of the stator A, forming main strokes of the gas engine, are made possible.

The stroke of the largest circumferential divergation or relative circumferential rotation between first and second rotating elements B1 and B2 determines also the greatest suction volume of air or fresh mixture, to which is also relevant the position of the holes provided on the sides A2*, A3* of the stator A and the position of the groove or depression of the hub 63 present on the first rotating element B1.

The rotation of the second rotating element B2, besides along the cylindrical side of the chamber 2, where it carries out its specific task of compressing the mixture previously taken in, continues of course inside the area of the chamber 1*, without touching its cylindrical wall that remains far apart.

In this stroke of rotation, the second rotating element B2 cooperates with the surface of the first rotating element B1, with the head of the third rotating element B3 and with the side walls of the chamber 1* of the stator A, for forming the expansion volume and for exhausting the burned gases that, by means of the flares 11 and the lateral draft through holes or openings 30, are forced toward the exhaust port 10.

Preferably, the port 10 does not directly accomplish the task of exhausting the burned gases, but it houses a rotating conduit 90, that has holes 91, 92 in correspondence to the bored flare openings 11 and through hole openings 30 of the central block of the stator A, and able to be aligned with said openings 11, 30, respectively, but only during the stroke of exhausting the burned gases, while in the other strokes, the conduit 90 is induced to turn so as to present its closed cylindrical surface adjacent to the holes.

The presence of the conduit 90, with its exhaust holes 91,92, constitutes the exhaust valve of the engine at issue, thanks to which the suction of the exhaust of the engine at issue is avoided.

The arrangement and adjustment of the holes 91,92 of the conduit 90, in order to present them to the openings 11, 30 of the stator A for the desired exhaust stroke of burned gases, is achieved, for example, by means of a crown gear 93 driven by the main shaft 80, by interposing another crown gear, a belt or a chain, or any other element able to achieve the proper reduced rotation rate, so that the desired exhaust phasing is achieved.

Nevertheless, the combustion of air and gas has always had the problem of incombustible hydrocarbon exiting the engine during the cleaning cycle.

Furthermore, the same solutions mentioned do not exclude the possibility of condensation to occur on the fresh walls of the combustion engine resulting in problems of lubrification and of a bad air-gas ratio resulting in premature and harmful lightings of the gas.

Technical Problem

The principal characteristics and object of the invention is to foresee the realization of an optimal thermodynamic cycle for a combustion engine, in which the phase of combustion and aspiration consists of activating in contemporary succession a cleaning phase of the various compartments, while acquiring the maximum motor force needed, thus activating the successive phase of aspiration and compression of the air for the successive combustion cycle and rendering particularly efficient the phase of aspiration that is optimised from the subdivision in two phases, primary and secondary, in order to guarantee the necessary depression at the interior volumes of the same aspiration, consequently resulting in better cooling of the motor.

An essence of the present innovation should be able to realize a thermodynamic cycle particularly applicable for an endothermic rotary engine with a double center of rotation for which the motor can be realized in such a way as to foresee the necessity of an external carburator, the motor can be created in a way to avoid the necessity of the presence of an external carburator, but still allowing the mixture of the air with the gas in a chamber directly in the working phase of the combustion engine, therefore also eliminating any type of loss of incombust gas, particularly in the cleaning phase of expansion chamber.

A subsequent goal of the present innovation with the improved and more complete combustion of the gas is to lower the level of pollution, other than increasing the performance of the combust gas.

An ulterior goal of the present innovation is to eliminate any type of condensation, even in the initial phase of ignition with a cold motor, with the consequent elimination of excessive lubrication and wrong air-gas combustion.

Another goal of the innovation is to create a thermodynamic cycle that can improve the structure and the functioning, specifically in the phase of aspiration of the motor, of WO 2004/020791, to also make it industrially feasible.

Technical Solution

This object is solved by a method for providing a thermo-dynamic cycle of an internal combustion engine having features according to claim 1, and by a thermo-dynamic rotatory engine with a double rotation center according to claim 20. Preferred aspects and embodiments are subject-matter of dependent claims.

Especially, there is provided a method for providing a thermo-dynamic cycle of the internal combustion engine, with double center of rotation, for better exploitation of the propulsion in the phase of combustion from the mixture gas, characterized from the fact that the same phase of combustion and expansion, beyond that of to produce the greatest power requested for the entire combustion, allows to contemporarily activate the succession at its channels or chambers, therefore finishing the expected inlet stroke of compression of the air for the successive cycle of combustion, particularly optimising the inlet stroke, that is realized in different times and chambers, to guarantee the necessary depression for the acquisition of the greatest volume of air, to then meet in the compression chamber, determining the especially most favourable compression ratio.

Advantageous Effects

Especially, there is provided a method for providing the thermo-dynamic cycle of the internal combustion engine, in particular of rotatory type with a double center of rotation, characterized from the fact that the cycle is able to be carried out in a rotary engine with two rotation centers, in which the rotation of rotating elements of a rotor in a stator chamber of a stator communicates between them and with an outside, beyond the combustion chamber forming a fifth room arranged in a timed, especially an optimally timed position of the stator.

Especially, such method is characterized from the fact that in this cycle the rotation of the rotating elements in the stator determines the formation of a chamber of leading suction forming a first room having also the function of expansion, beyond that of a compression forming a second room, and of a secondary suction in a third room and of a collector forming a fourth room, which are advantageously communicating between them, beyond the combustion chamber forming the fifth room and with the outside environment taking in air and combustion fluid.

Especially, there is provided such a method, characterized from the fact that in this cycle the chamber of the leading suction and of expansion forming a/the first room is communicating with the combustion chamber forming the fifth room, for intervention of an adjustable tenth opening, beyond that to be communicating with the outside environment by means of a valve, that is provided by a suction pipe formed as a first conduct and a discharging conduct formed as a second conduct that are interconnected in a passage forming a first outside opening of the first room.

Especially, such a method is characterized from the fact that in this cycle the chamber of the leading suction and expansion formed in the first room is communicating directly with a/the collector chamber formed in a/the fourth room, by means of a passage forming a seventh opening created with the same motion of the rotating elements in the stator that also determines their function as a first piston in the chamber forming the first room.

Especially, such a method is characterized from the fact that in this cycle the chamber of the leading suction and of expansion formed in the first room is indirectly communicating with the collector chamber formed in a/the fourth room, by means of an inside passage or pipe that is regulated from an access valve forming an eighth opening.

Especially, such method is characterized from the fact that in this cycle a/the compression chamber forming a/the second room is communicating with the combustion chamber forming the fifth room, for intervention of an adjustable passage forming an eleventh opening.

Especially, such method is characterized from the fact that in this cycle the compression chamber forming a second room is communicating with a collector chamber forming a fourth room, by means of adjustable passages forming third to sixth openings created with the motion of the rotating elements in the stator that also determines their function as a second piston in the second room.

Especially, such method is characterized from the fact that in this cycle a secondary room of suction forming a/the third room is communicating with the outside environment by means of a passage forming a second opening and is communicating with the collector chamber forming a/the fourth room by means of inside passages forming a fourth opening and a fifth opening, created with the motion of the rotating elements in the stator and it also determines their function as a third piston in the third room.

Especially, such a method is characterized from the fact that in this cycle a collector chamber forming a/the fourth room is communicating with the leading room of suction and of expansion forming the first room, with the compression chamber forming a/the second room and with the secondary room of suction forming a/the third room, the chamber forming the fourth room having created and communicated with the fourth chamber with the rotating elements in the stator.

Especially, such a method is characterized from the fact that in this cycle the collector chamber forming the fourth room is able to communicate directly with the outside environment, through the presence of a passage forming a ninth opening.

Especially, such a method for providing a thermo-dynamic cycle of internal combustion engine of rotatory type with double centers of rotation is characterized from the fact that the phase of combustion of the mixture, contained in a/the fifth room, follows the phase of expansion of the burned gas in a chamber forming a/the first room, determining an increasing volume of expansion that constitutes the contained volume of the volume that meets the remaining inside volume of the engine, constituting a washing volume, as exemplified in FIG. 22.

Especially, such a method is characterized from the fact that during the phase of expansion of the volume of expansion there begins a secondary inlet stroke with a formation of a backside volume increasing the pressure in the washing volume until up to the beginning of an exhaust stroke of the burned gas, as exemplified in FIG. 23.

Especially, such a method is characterized from the fact that, continuing the exhaust stroke, a/the eleventh passage at the fifth room is opened that determines the communication between all the chambers insides, with exclusion of the chamber forming the backside volume, forming a sole chamber being the washing volume that obtains the entire leakage of the burned gas from the engine, by means of a/the pipe formed by a second conduct of a/the valve, as exemplified in FIG. 24.

Especially, such a method is characterized from the fact that, while continuous opening of a/the pipe formed by a second conduct of a valve and increasing a/the backside volume of a secondary suction, the conclusion of a/the phase of washing is started and a cooling of the chamber is started, as exemplified in FIG. 25.

Especially, such a method is characterized from the fact that, with conclusion of a/the phase of washing and therefore the closing of a/the pipe formed by a second conduct, a compression stroke forming a compression volume it is started, while a/the secondary inlet stroke forming a/the backside volume is continuous as exemplified in FIG. 26.

Especially, such a method is characterized from the fact that, when a/the backside volume reaches its greatest expansion to get ready to merge itself with a primary volume, to form a primary inside volume that is increased from the conducts of suction, because of a developed depression from a/the decreasing of a/the compression volume, as exemplified in the FIGS. 27 and 28.

Especially, such a method is characterized from the fact that, with the achievement of the greatest air pressure, the compression, volume is annulled, being the same air completely confined in the room of explosion forming a/the fifth room, conveniently having mixed with the fuel introduced from injectors, for its phase of combustion, as exemplified in FIG. 29.

Especially, such a method for providing the thermo-dynamic cycle of the internal combustion engine, particularly of rotatory type with a double center of rotation, is characterized from the fact that a/the a second conduct of a/the valve remains open for the greater time of discharging, to avoid every overpressure in the initial phase leading suction to form a/the primary inside volume.

Especially, there is provided a thermo-dynamic rotatory engine with a double rotation center, for performing such a method, characterized from the fact of being perfected especially in the suction elements forming a/the a first conduct and of discharging forming a/the a second conduct on the valve, on the pipe of discharging and on the variation of the function of the pipe of alimentation of the stator, like substantially described and illustrated from 12 to 19.

Especially, there is provided such a thermo-dynamic engine, characterized from the fact that a shaft volume is put in communication with resting primary and backside volumes, from an opening within a seat of a/the rotor or from a pipe on a stem of the seat.

Especially, such a thermo-dynamic engine is characterized from the fact that in a/the compression chamber forming a/the second room an injector of the fuel, beyond that of a specific position in a/the combustion chamber forming a/the fifth room, can be alternately applied in the especially optional time position of its cylindrical surface or on the side for its protection from the temperature and from the compression pressure of the compression chamber.

### DESCRIPTION OF DRAWINGS

An embodiment of the invention and other goals are in effect especially perfectly achieved with the realization of a cycle with the cycle of the present innovation, furthermore as simply indicated in the following claims and accompanied with illustrations, with a succession of simplified phases that are not limited, with the appending schematic figures. In all drawings, the same parts are represented or are understood as represented by the same reference number, while, for representation and interpretation practicality, the different elements are sometimes illustrated with full lines even when they overlap with other elements and should be represented with dotted lines.

FIG. 1 represents a two-dimensional drawing of an attachment between different pockets or chambers that are feasible in a combustion engine of the type proposed with WO 2004/020791, whose diagram is fit to illustrate the presence of the same chamber, hollow, flare or outlet hole and the accomplishment of the cycle in examination as such.

FIG. 2 represents the same drawing of FIG. 1, with a disposition and communication of the volumes in the phase of explosion of the gas.

FIG. 3 represents the same drawing of FIGS. 1 and 2, with the volumes represented in a phase of expansion of the cycle, that is immediately successive to the phase of explosion of FIG. 2.

FIG. 4 represents the same diagram of FIG. 1, with the volumes represented in a phase successive to those of FIG. 3, in which the secondary inlet stroke started.

FIG. 5 represents a successive phase to that of FIG. 4, in which there is the beginning also of the exhaust stroke of the burned gas, continuing the secondary suction.

FIG. 6 represents a successive phase to that of FIG. 5 that continues the exhaust strokes of the burned gas of the secondary suction.

FIG. 7 represents a successive phase to that of FIG. 6, in which there is the beginning of the washing of the inside volumes of the engine, while continuing the secondary suction.

FIG. 8 represents a successive phase to that of FIG. 7, which continues the phases of washing of the engine of the secondary suction.

FIG. 9 represents a successive phase to that of FIG. 8, which continues the phase of washing, with the greatest volume of the room of expansion, creating the conditions for the re-raising of the piston, while the volume of compression is closed from the air previously inhaled.

FIG. 10 represents a successive phase to that of FIG. 9, in which the compression air stroke begins, while it is concluded the phase of exit of the washing gas, with the gradual completion of the secondary inlet stroke.

FIG. 11 represents a successive phase to that of FIG. 10, in which the compression stroke of the air continues while the secondary suction is concluding.

FIG. 12 represents a successive phase to that of FIG. 11, in which the compression stroke of the air continues and the secondary inlet stroke is finished.

FIG. 13 represents a successive phase to that of FIG. 12, in which the volumes of air are not subject to compression, and in which they unite themselves and mix between them, giving origin to the leading suction.

FIG. 14 represents a successive phase to that of FIG. 13, in which the greatest volume of air is inhaled.

FIG. 15 represents a successive phase to that of FIG. 14, in which the phase of the suction of air is completed with the closing of the suction valves and also of the valve intervened between the chamber, hollow, flare or outlet hole one of compression and the ignition chamber.

FIG. 16 represents a successive phase to that of FIG. 15, in which the volumes of the engine are arranged in the ideal condition that precedes the phase of explosion and allows the resumption of the cycle, as already described in reference to FIG. 2.

FIG. 17 represents the view of a diagram of the attainable values of pressure in the combustion chamber of the engine of FIG. 1, which is traced in correspondence with the moments represented from FIGS. 2 to 16.

FIG. 18 represents the view of the same diagram to that of FIG. 17 but referred to the values of the pressure of the chamber of secondary aspiration of the engine in FIG. 1.

FIG. 19 represents the view of the same diagram to the diagrams of FIGS. 17 and 18 but referable to the values of the leading pressure in the engine of FIG. 1.

FIG. 20 represents the view of a diagram that summarizes and associates the values of the pressures of FIGS. 17-18 and 19 and of their correlation in correspondence of the situations of FIGS. 2 to 16, to emphasize the efficiency of the thermodynamic cycle.

FIGS. 21 to 29 represent also schematic transversal view of the endothermic engine I rotated, of the type proposed with WO2004/020791, whose structure was perfected and adapted to be able to achieve the varied phases of figures from 2 to 16 and according to the corresponding diagrams of the FIGS. from 17 to 20. Particularly:

FIG. 21 represents a transversal view of the design of the endothermic rotary engine in a disposition of its elements for a situation corresponding to the phase of explosion of the diagram of FIG. 2.

FIG. 22 represents a schematic view of the same view of FIG. 21, in which the successive phase of expansion is represented, corresponding to the diagram of FIG. 3.

FIG. 23 represents a schematic view that is the same to FIGS. 21 and 22, in which an initial phase of discharging is represented and a suction secondary, corresponding to the phases of FIGS. 5 and 6.

FIG. 24 represents a schematic view of the same view of FIG. 23, in which an initial phase of washing is shown, corresponding to the phase of FIG. 7.

FIG. 25 represents a schematic view of same to the diagram of FIG. 24, in which it continues the washing phase and the secondary suction corresponding to FIG. 8.

FIG. 26 represents a schematic view of the same diagram of FIG. 25, in which the phase of washing is finished, while creating the conditions for repositioning of the piston in the room of expansion, and the chamber, flare or outlet hole one of compression is closed, corresponding to FIGS. 9 and 10.

FIG. 27 represents a schematic view of the same diagram of FIG. 26, in which the phases of washing and of secondary suction are finishing, while the compression stroke continues, as indicated in FIGS. 11 and 12.

FIG. 28 represents a schematic view of the same diagram of FIG. 27, in which the compression stroke continues and begins the leading inlet stroke, as represented in the FIG. 13.

FIG. 29 represents a schematic view of the same diagram analogous to FIG. 28 and is substantially identical to the diagram of FIG. 21, in which the compression phases that precede the explosion complete themselves, while contemporary it has the greatest suction and mixing of the air of the successive cycle, as represented in FIGS. 14-15 and 16.

FIG. 30 represents a perspective view and partially exploded view of some parts of the engine that is object of WO 2004/020791 as such, like already indicated in from FIGS. 21 to 29, with special emphasis of the group of primary air suction and the discharging of the burned gas.

FIG. 31 represents a perspective view of the same engine of FIG. 30, being represented by lacking its sides and with the group of suction and discharging especially exploded for better viewing.

The FIG. 32 represents a preferred ideal view, for the lengthwise section of the engine of FIGS. 30 and 31, illustrating especially their group of suction and discharging.

FIG. 33 represents a transversal view of the engine in examination, substantially identical to the view of FIG. 26, illustrating some of its parts referred to the suction and discharging, of which FIGS. 30 to 32 can be referred to.

In all the figures the same details are represented with the same number of references in order to be self explanatory.

### MODE FOR INVENTION

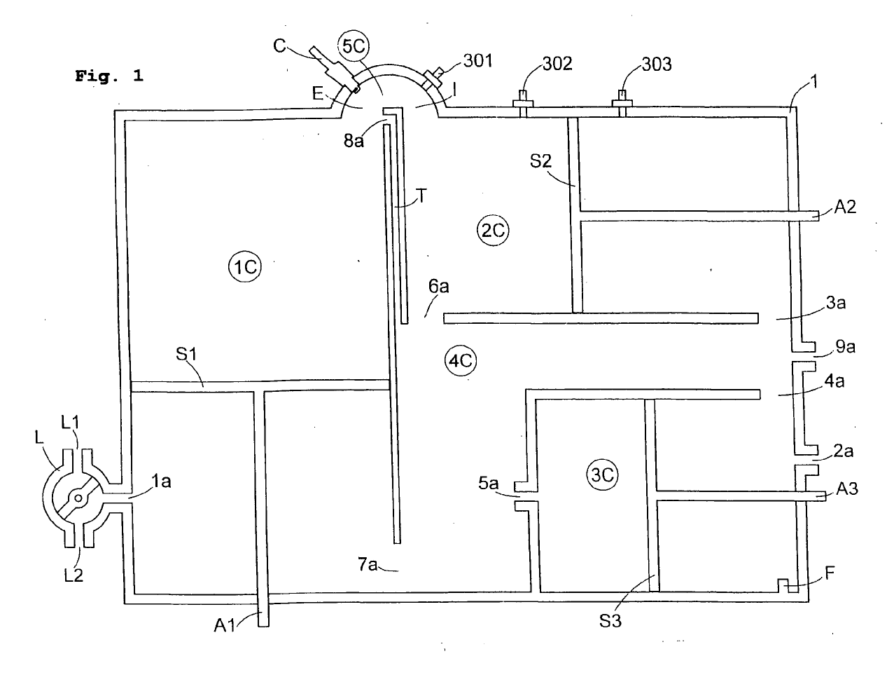

According to the two-dimensional diagram of engine of the FIGS. 1 to 16, various chambers that allow to realize an endothermic cycle are present and variable in volume, beyond that between them is varied communication, due to the structure of engine that has a double rotation center.

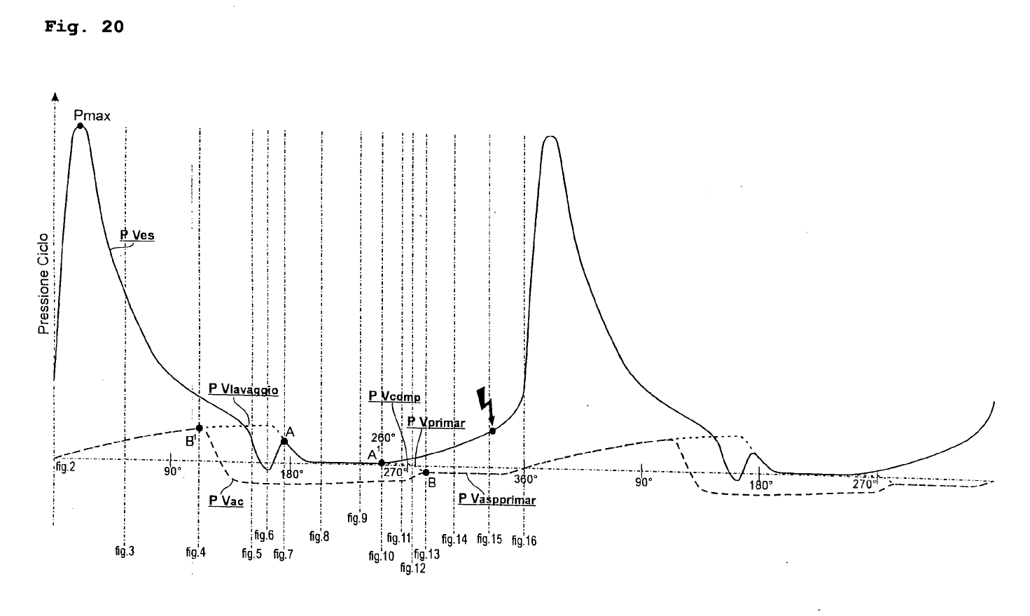

An engine 1 as already substantially proposed in the patent application WO2004/020791 and with subsequent adaptations is specified in the FIGS. from 21 to 29, and in FIGS. 20-33 in more details.

With special reference to the FIG. 1, an engine 1 it is composed of some rooms or paths, especially a first room 1C, a second room (2C), a third room (3C), a fourth room (4C), and a fifth room (5C) that communicate between them by means of timely passages, as better specified bellow.

The first room 1C is the place where an expansion of a combustion gas happens, that is to say where the profitable phase of a cycle is realized, together with an alternate leading inlet stroke. First room 1C is provided with an adjustable outside opening la towards an outside and with three adjustable seventh, eighth, and tenth openings 7a, 8a, and E towards an inside of the first room 1C.

Particularly, the tenth opening E communicates between the first room 1C of expansion and the fifth room 5C being a combustion chamber, while the eighth opening 8a communicates with an inside passage T that, which in due time, communicates with the fourth room 4C, that act as a collector of the engine 1 for the cycle.

The outside opening 1a of the first room 1C is connected to a valve L leading into two positions, that is fit to deviate alternately a flow of suction of the flow of inspiration air entering in the first room 1C, by means of a first conduct L1, and a flow of burned gas exits from the same first room 1C, by means of a second conduct L2 or discharging conduct.

According to the two-dimensional diagram of FIG. 1, entitled first room 1C a first piston S1 is provided having a component A1 that guides the path of it and exits from the engine 1, to establish the useful force of work from the first piston S1, when it is pushed from the combustion gas of the same engine 1.

The second room 2C has the function of rotation, compression and passage of the air to the combustion chamber being the fifth room 5C and is in connection with the fifth room 5C through an eleventh opening I.

Second room 2C communicates also with the collector being the fourth room 4C, by means of its openings being a third and sixth openings 3a and 6a that are laid out by to two end of its length. Especially, the third and sixth openings 3a and 6a are constructed by outer ends of a wall being opposite to an outer wall of the second room 2C and of the engine 1.

The same second room 2C is equipped with a second piston S2 having a rod like component A2 that exits from the engine 1, on which the component A2 are applied the necessary forces for a passive work to finish the second piston S2 to translate along a long extension of the second room 2C, especially to compress the air to be mixed to a mixture and to introduce it into the room of explosion being the fifth room 5C.

The third room 3C has the function of secondarily alimentation of air, always to compose the combustible mixture, and is so provided of an opening of air being a second opening 2a towards the outside of the engine 1.

The third room 3C communicates also with the collector chamber being the fourth room 4C, by means of internal fourth and fifth openings 4a, 5a that are arranged at a base and at a head of its length.

The same third room 3C is equipped with a third piston S3, whose piston rod like component A3 action exits from the engine 1 and the rod like component A3 of which applies the necessary forces for the passive work to finish the third piston S3 to translate the same third room 3C, especially for the acquisition of the secondary nutrition.

Finally, the third room 3C is provided of an end of path F, e.g. a stopper wall, that is fit to limit the race of the third piston S3. Especially, the end of path F limits the movement of the third piston 3C in direction of an outside wall of the engine 1.

The fourth room 4C, that is already cited, is the collector of the first to third rooms 1C, 2C, and 3C and communicates with the openings, especially to the third to seventh openings 3a, 4a, 5a, 6a, and 7a, beyond that with the conduct formed by the inside passage T and its adjustable eighth opening 8a.

As already specified, the first outside opening 1a of the first room 1C, other than being a closing system, communicates with the valve L, that is fit to deviate the entry of the flow of open air, through entry formed by the first conduct L1, or to exit the flow of the discharge of gas from the expansion room being the first room 1C, through the exit formed by the second conduct L2.

A further, ninth entry opening 9a, complementary to the entry formed by the first outside opening 1a, can be associated to the collector formed by the fourth room 4C, to aid the access of free air as represented in FIG. 1.

As already cited, the two-dimensional diagram of the engine 1, that is exemplified in FIGS. 1 to 16, has only a simplified descriptive function of the rooms and of the operation of the cycle that is feasible with the engine of the type WO2004/020791, hypothesizing that every opening 1a-8a is ideally without losses of load and that their closing or opening is ideal as well, as it is hypothesized that every piston S1, S2, and S3 is ideally without friction and that the walls be ideally lacking heat transmission of every shape, friction, etc., if not otherwise specified.

With these pretexts, the cycle in examination is described, conforming with the succession of phases illustrated in the various phases in FIGS. from 2 to 16 and with referral to the diagrams of FIGS. 17 to 20.

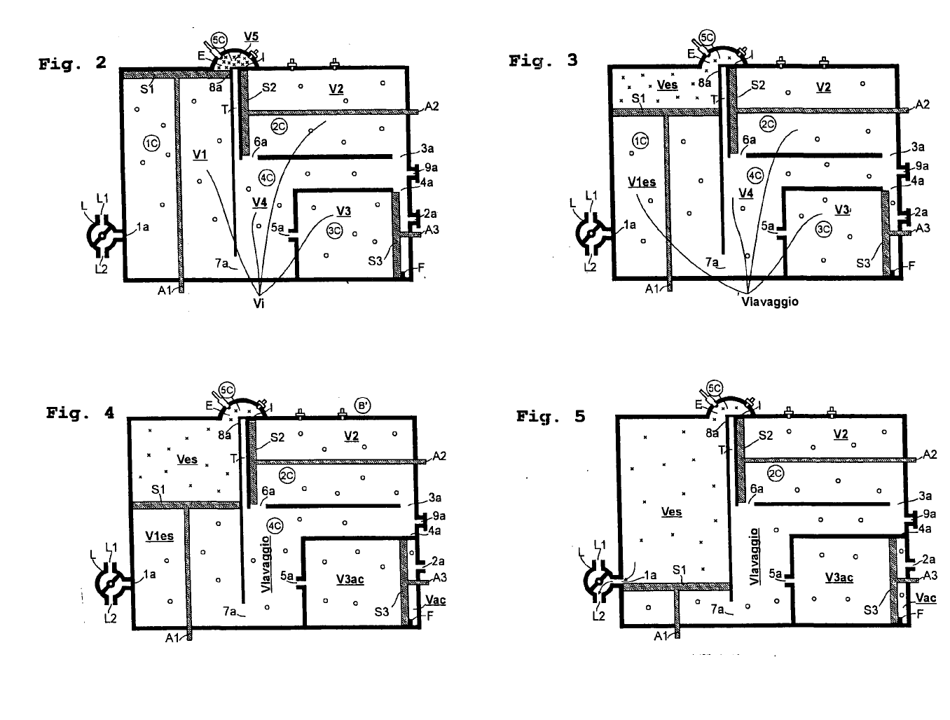

FIG. 2 illustrates the situation of the engine 1 in the phase of explosion of fuel in the fifth room 5C, in which situation the first piston S1 is arranged at the end of path in the first room 1C, while the second piston S2 is arranged at the end of its race greatest length in the second room 2C and the third piston S3 is all beginning of its course in the secondary room of aspiration being the third room 3C. In other words, the first and second pistons S1, S2 are moved to the opposing sides adjacent to the tenth and eleventh openings E, I, respectively, and the third piston S3 is retracted to the end of path F.

In this situation the passages formed by the third to seventh and the tenth openings 3a, 4a, 5a, 6a, 7a, and E are open, while the passages formed by the first, second, eight, ninth, and eleventh openings 1 a, 2a, 8a, 9a, and I are closed, in such manner that in the various rooms, especially the first to fourth rooms 1C, 2C, 3C, and 4C the air is present with its first to fourth volumes V1, V2, V3, and V4 forming a total inside volume Vi having ambient pressures and temperatures, while in the fifth room 5C it is a mixture of air and gas is found that has been previously compressed, that cannot go out because the passage (I), is closed, while opening (E) is open and puts in communication the fifth room 5C with the first room 1C. Especially, the total volume Vi is calculateable by Vi=V1+V2+V3+V4.

In these conditions, the combustion of the gas mixture is provoked, for example by means of a spark plug C reaching into the fifth room 5C, according to an any one of the techniques known as such. In the conditions illustrated in FIG. 2, the second piston S2 located in the chamber, flare or outlet hole one of the compression chamber formed by the second room 2C in its position of greatest progress, determining its inside volume forming the second volume V2, to the net thickness of the same second piston S2, whose volume corresponds to the same compression chamber formed by the second room 2C, and so like the third volume V3 corresponds substantially to the volume of the third room 3C.

In FIG. 3 the initial phase of expansion of the gas of combustion in the room formed by the fifth room 5C is represented that, across the tenth opening E, work on the first piston S1 pushing it towards the other end of the first room 1C and determining a volume of expansion Ves that allows the usage of energy produced from the combustion, for means of the force of the rod like component A1 having function like a piston rod of the first piston S1.

In the meanwhile, at the beginning of the lowering of the first piston S1, the first outside passage 1a is closed, in manner that the present volume of air V1es on side of the piston rod like component of the first room 1C, passing through the seventh opening 7a, unifies itself with the air compressed in the fourth, third and second volumes V4, V3, and V2 of the other rooms, that is the fourth, third and second rooms 4C, 3C, and 2C, and reduce themselves with respect to the volume of expansion Ves of the expansion combust gases.

Indicated are with Vt total volumes of the first to fifth rooms 1C, 2C, 3C, 4C, and 5C, therefore with Vi the sum of the inside volumes of free air circulation of the inside and outside of the combustion chamber formed by the fifth room 5C, beyond the volume of expansion Ves the part already seen with first volume V1 in expansion, and with the present volume of air V1es on side of the piston rod like component of the first piston S1, forming the staying volume of the same first room 1C, the following equivalences are present: Vt=V1+V2+V3+V4+V5; Vi=Vt−V5; V1=V1es+Ves, where V1, V2, V3, V4, and V5 are the net volumes of the first to fifth rooms 1C, 2C, 3C, 4C, and 5C as also specified.

In FIG. 4 a successive phase of expansion of the burned gas is represented by volume of expansion Ves in which, continuing the course of the first piston S1, for the development of the volume of expansion Ves to loss of the volume of air V1es on side of the piston rod like component, the passage formed by the fourth opening 4a is obstructed, for connection between the collector formed by the fourth room 4C and the secondary suction room formed by the third room 3C.

The third volume V3 corresponds to the inside volume of the third room 3C to the net one of the thickness of the third piston S3 and, with the closing of the passage formed by the fourth opening 4a and the opening of the passage forming the second opening 2a, therefore with the beginning of the secondary inlet aspiration, determines the formation of two volumes V3ac, Vac in the third room 3C that has the equivalence: V3=V3ac+Vac, while the closing of the fourth valve 4a obliges the air to be inhaled from the sole second opening 2a. One of these volumes being a front side volume V3ac between the third piston S3 and the fifth opening 5a, and the other being a backside volume Vac at the side of a piston rod like component of the third piston S3.

In this phase, the secondary suction in the third room 3C and the expansion of the combustion gas in the volume of expansion Ves in the first room 1C happen simultaneously and losses the remaining inside volume Vi, for that the following equivalences are: Ves+Vac+V1es+V3ac+V2+V4=Yourselves, determining Vlavaggio=Vi−Ves−Vac.

The restrained air with a restrained or washing volume Vlavaggio, as the volumes formed by the volume of expansion Ves and by the backside volume Vac increase, and not having a means of escape, reduced themselves to the internal volume Vi and therefore the air is compressed.

In FIG. 5 there is represented the beginning of the phase of expulsion of the burned gas, when the first piston S1 reaches the position of the passage forming the first outside opening 1a, which therefore is opened and, upon disposition of the valve L in the condition of discharging to the second conduct L2, allows the leakage of the burned gas.

The residue of the burned gas remains at ambient pressure on the inside of the volume of expansion Ves of the first room 1C that reaches its greatest useful value for maximum profit of the engine. Simultaneously, with the progress of the third piston S3 in the third room 3C there is an increase in the backside volume Vac determining the smallest volume of air or fluid according to the restrained washing volume Vlavaggio in the second to fourth rooms 2C-4C and, in part always decreasing, of the first and third rooms 1C and 3C, determining therefore the greatest value of the pressure of the fluid according to the restrained volume Vlavaggio or fluid of washing.

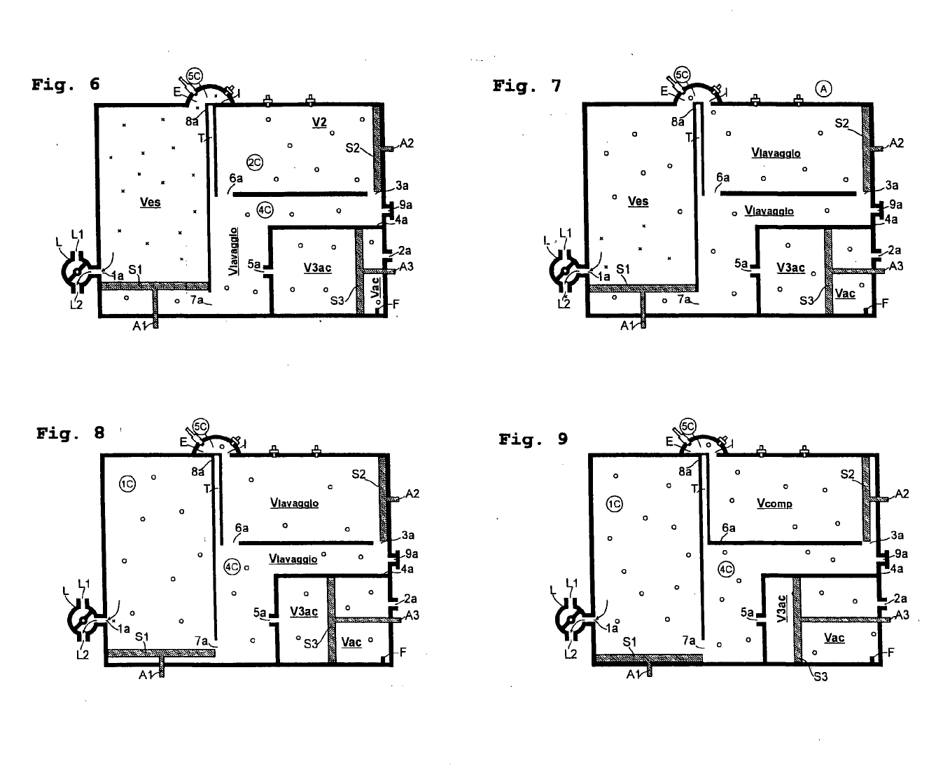

In FIG. 6, the rapid repositioning of the second piston S2 in its initial condition that is withdrawn in the compression chamber formed by the second chamber 2C, also in force of the persistent opening of the passages forming the sixth, third openings 6a-3a, determining a phase of precleaning of the second room 2C with the arrival of the fluid according to the restrained washing volume Vlavaggio from the sixth, third openings 6a-3a with the collector formed by the fourth room 4C.

In these conditions the pressure of the fluid of the restrained volume Vlavaggio, the backside volume Vac at third piston S3 and the volume of expansion Ves at first piston S1 does not change with respect to the situation of FIG. 5. Particularly, volume of expansion Ves is always at environmental pressure, also for the persistent closing of the valve formed by the eleventh opening I.

FIG. 7 represents the initial phase of washing that interests all of the inside volumes with exception of the backside volume Vac at third piston S3, following also the eleventh opening of the valve formed by eleventh opening I that allows the fluid according to the restrained washing volume Vlavaggio to enter in the fifth and first rooms 5C and 1C, pushing the remaining burned gas verse towards the exit formed by the first outside opening 1a.

Consequently, all of the total volume Vt is at pressure environment and saturated of fluid “fresh”, except for the backside volume Vac of the third room 3C, which forms an air room that is momentarily separated, even if substantially it is in environmental pressure, being open on the outside channel formed by the second opening 2a, at any rate containing some “fresh” fluid.

In FIG. 8 an intermediate moment of the phase of washing is represented, in which the first piston S1 is started to complete its race of expansion in the first room 1C, open the passage forming the seventh opening 7a with the adjacent collector forming the fourth room 4C and allowing the exchange of the fluid also from the same collector forming the fourth room 4C, to make it go out from the passage forming the first outside opening 1a.

Simultaneously the progress of the third piston S3 in the third room 3C, favours the exchange of fluid or washing, while it allows for the growing in volume of the fresh fluid in backside volume Vac of the same third room 3C.

Naturally, the expansion of the backside volume Vac obliges part of the restrained fluid in the engine 1 to go out from the first outside opening 1a after having contributed to the cooling of the engine 1.

FIG. 9 represents the continuation of the washing phase, in the moment of the closing of the sixth passage 6a and an isolated compression volume Vcomp is created that coincides with the volume of the second and fifth rooms 2C and 5C, in the meantime valve formed by tenth opening E is closed, while the advancement of the third piston S3 in the third room 3C, with its front side volume V3ac compels the remaining gas from the passage forming the first outside opening 1a.

In this phase there is the greatest useful volume of the expansion room forming the first room IC, creating the conditions of imminent return of the first piston S1.

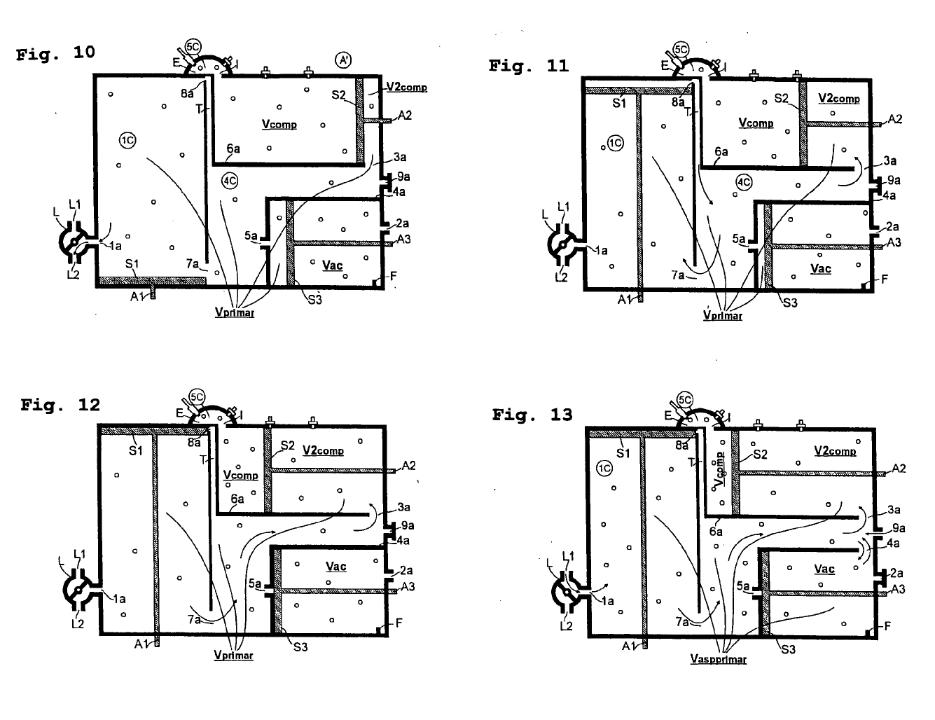

In FIG. 10, with the greatest fresh volume of fluid, the phase of washing is concluded and the opening of the passage forming the seventh opening 7a, with the opening of the passage forming the eighth opening 8a of the inside chamber or channel formed by the inside passage T, there is a uniform ambient pressure in the first and fourth rooms 1C and 4C, while the backside volume Vac of the third room 3C continuous its expansion, always inhaling air by vacuum from chamber or channel forming the second opening 2a.

Simultaneously, with the progress of the second piston S2 in the second room 2C, the beginning of the compression stroke of the fluid in the compression volume Vcomp and the formation of a second volume V2comp which, thanks to the cumulation of volumes formed by the backside volume Vac and by the second volume V2comp, can create a further expulsion of the remaining fluid from the conduct forming the first outside opening 1a.

The moving second and third pistons S2 and S3, determine an initial phase of internal compression, with a greater development of the backside volume Vac with respect to the second compression volume V2com. To maintain the environmental pressure in the primary volume Vprimar=Vi−Vcomp−Vac the passage forming the first opening 1a is still open because, if the first opening 1a were closed it could develop an increment of pressure in the primary volume Vprimar and this would be an unwanted effect with respect to the optimisation of the successive inlet stroke.

In FIG. 11 an intermediate phase of the cycle in examination is represented of a gradual progress of the second piston S2 in the second room 2C, where the compression of the air in the compression volume Vcomp, had a sudden return of the first piston S1 to the initial position of FIG. 2.

As the first piston S1 returns it recycles the fluid restrained in the first room 1C across the passage forming the eight opening 8a and the channel formed by the inside passage T, therefore, across the fourth room 4C, it makes it return mainly to the volume of the first room 1C. In this phase occurs the mixing of the air contained in the primary volume Vprimar, contributing to the expulsion of the last remaining gas from the channel forming the first outside opening 1a.

FIG. 12 represents a successive intermediate phase of the cycle in examination, with the continuation of the compression of air in the compression volume Vcomp with the progress of the second piston S2 of the second room 2C, while the third piston S3 arrives at the bottom to the third room 3C putting an end to the secondary suction, giving the greatest development to its backside volume Vac at third piston S3, while the primary volume Vprimar remains substantially constant.

FIG. 13 represents the beginning of phase of primary aspiration of the fluid of the valve L, such suction, beyond that for the positioning of the valve L in the condition of connecting the first outside opening 1a with the first conduct L1, having given possible for the depression created from the reduction of the compression volume Vcomp, because of the motion of progress of the second piston S2, therefore increases the second volume V2comp in the second room 2C.

Simultaneously, the passages forming the second and eighth openings 2a and 8a close themselves while the passage forming the fourth opening 4a opens, which determines a mixture of the fresh fluid in the primary and the backside volumes Vprimar and Vac producing a primary inside volume Vaspprimar. Vaspprimar=Vprimar+Vac.

FIG. 14 represents the conclusion of the inlet stroke across the valve L and the open passage forming the first outside opening 1a, and the compression of the air relating to the compression volume Vcomp subsequently achieves its greatest value, pushing the same air in the combustion room forming the fifth room 5C, with the end of course of the second piston S2 approaching, the closing of the valve formed by the tenth opening E and the opening of the valve formed by the eleventh opening I.

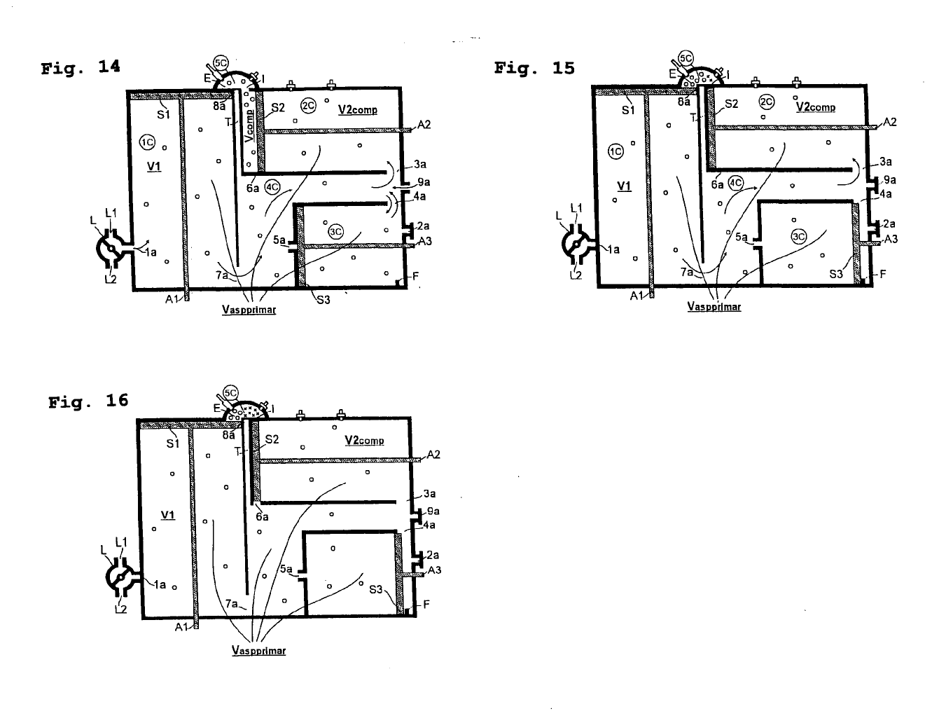

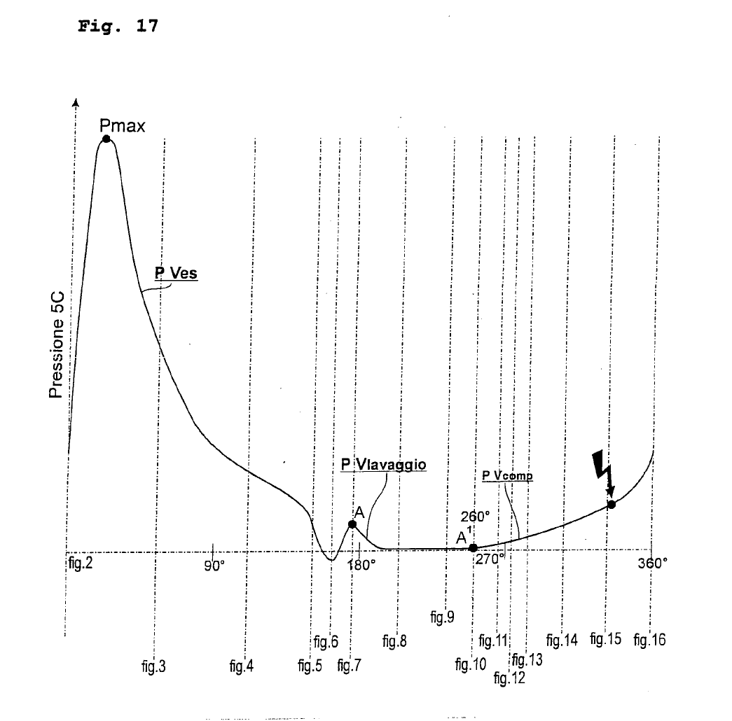

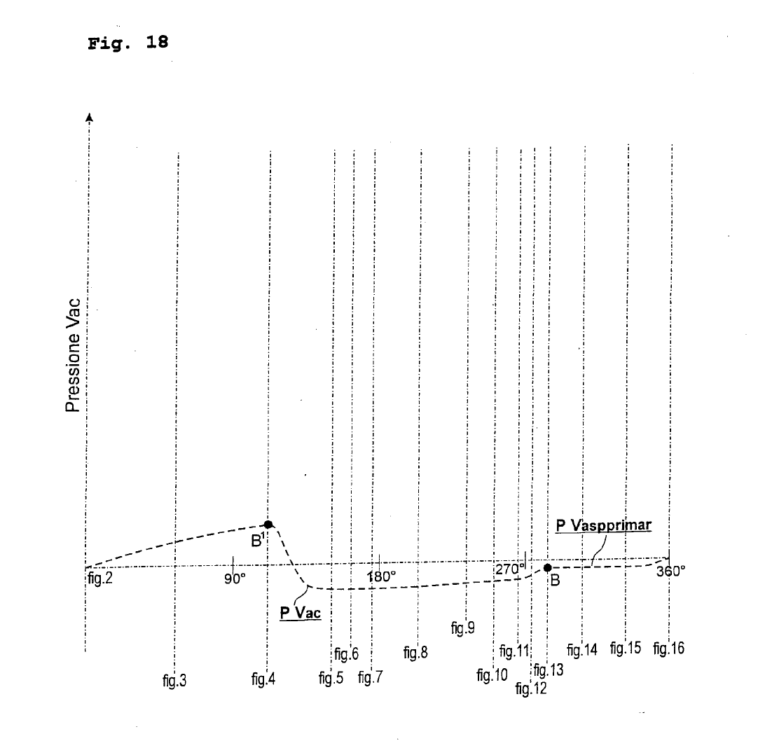

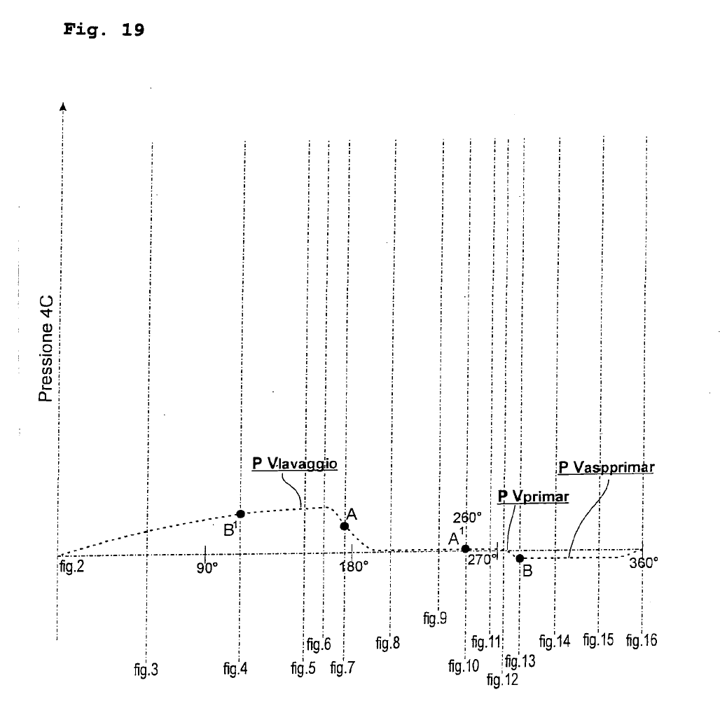

FIG. 15 represents the greatest extension of the volume of the inhaled air Vaspprim which besides the first volume V1 of first room 1C and to the second volume V2comp of second room is extended also to the part of the third and fourth rooms 3C and (4C) coinciding with the total volume Vi. The third piston S3 returns to its initial position of FIG. 2a in an ideal manner without provoking a thermodynamic transformation. Simultaneously the conduct forming the eleventh opening I is closed and the valve forming the tenth opening E is opened, and the first and ninth passages 1a and 9a close themselves. With the return of the third piston S3 to the initial position, the valve L is deviated in its position of “discharging” connecting the first outside opening with the second conduct L2.

FIG. 16 represents the situation immediately successive to that of FIG. 15 and it corresponds to the same situation of FIG. 2, where the fifth room 5C is ready for the phase of combustion, while, with the return of the third piston S3 to the initial position and the closing of the passage forming the eight opening 8a, the remaining part of the motor contains the fresh fluid at ambient pressure Vaspprimar, that was previously aspired by the entry formed by the first and second outside openings 1a and 2a.

The thermodynamic cycle is therefore ready for a new combustion of the mixture in a chamber, flare or room forming the fifth room 5C repeating the dimensional diagram of FIGS. 2 to 16.

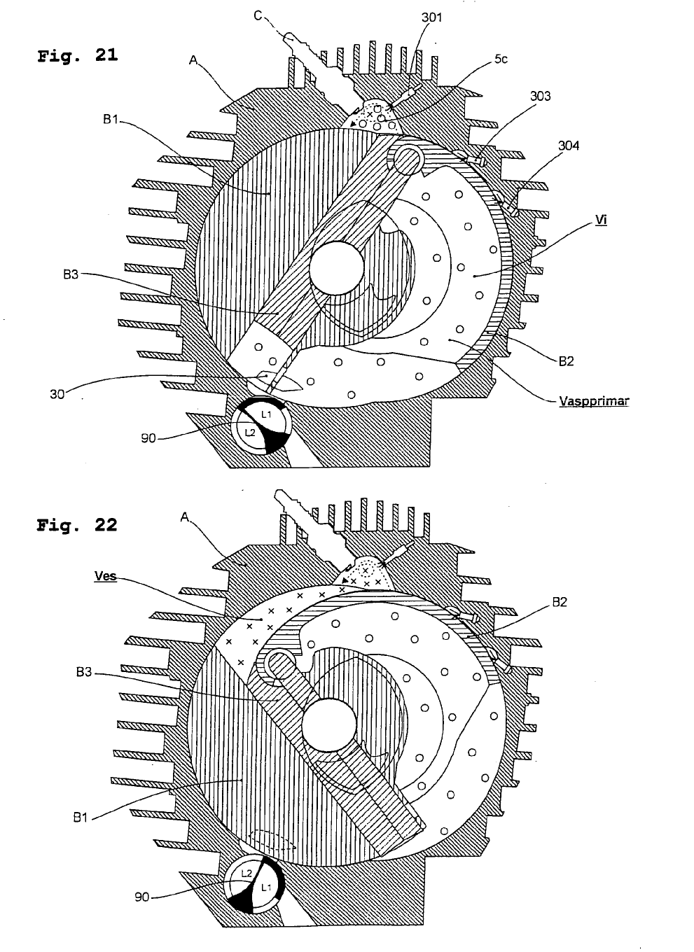

As already cited, with the FIGS. 17 to 20 it illustrate the same phases of the cycle until now described in the various FIGS. from 2 to 16, representing the cycle according to the diagrams of pressure of three significant volumes for the determination of the same cycle, indicating vertically the value of the respective pressures and the horizontal angular breadth of the ideal unwinding of the cycle from 0° to 360°, as represented in FIGS. 21 to 29, that concludes the constructive bi-dimension of the engine 1 of the various figs. from FIGS. 1 to 16.

Particularly, FIG. 17 represents the theoretical diagram of the present pressure in the combustion room formed by the fifth room 5C, during the various phases that were cited above, while FIG. 18 represents the theoretical diagram of the pressure of the backside volume Vac at the third piston S3 with the downstream air of the third piston S3, FIG. 19 represents the theoretical diagram of the pressure of the air in the collector formed by the fourth room 4C and the FIG. 20 represents the assembly of the pressures, or better the cycle of the system.

In FIGS. 17 to 20 there is represented a course of the pressures that is deliberately indicated, as in any endothermic engine, the evolution of the pressures and of the curves that characterize them, greatly gradually influenced from the quantity of fuel introduced, from the number of turns of the engine, from the carburation, from the time of ignition, from the losses of load of the openings and conducts, and other possible factors.

With special reference to FIG. 20 and the relevant positions of reference to the FIGS. from 2 to 16, it is verified a rapid increase of the due pressure of expansion to the phase of combustion in the chamber formed by the fifth room 5C. It is obtained the achievement of a greatest value Pmax of the pressure of expansion, with a certain delay with respect to the switching on. Simultaneously it is had an increase of the pressure in the collector formed by the fourth room 4C that has identical values and with superimposable course to the value of the backside volume Vac until the achievement of a point B′. The pressure in the backside volume Vac increases for effect of the opening of the passage forming the fourth opening 4a that leaves penetrate the air in the smaller backside volume Vac between the third piston S3 and the far wall.

With particular reference to FIG. 20:

The diagram in the position of FIG. 2, indicates the beginning of the combustion phase, in which the pressure in the combustion chamber formed by the fifth room 5C increases rapidly till it reaches the greatest value Pmax of the pressure.

The diagram in the position of FIG. 3, with the end of the combustion phase with the increase of the volume of expansion Ves the pressure in the fifth room 5C decreases rapidly, while the pressure increases restrained volume Vlavaggio. In this phase the restrained or washing volume Vlavaggio also includes the usage of the independent backside volume Vac.

The diagram in the position of FIG. 4, with reference to the point B′, thanks to the closing of the fourth opening 4a, the backside volume Vac is dissociated from the washing volume Vlavaggio) whose pressure continues to ascend, while the pressure in the backside volume Vac falls rapidly until it becomes inferior to the atmospheric one of a value that depends from the losses of load to the second opening 2a. Both in the phase of secondary aspiration.

In diagram in the position of FIG. 5 emphasizes the exhaust stroke, where the pressure in the volume of expansion Ves and in the fifth room 5C comes down to atmospheric values while the pressure of the backside volume Vac remains inferior to the atmospheric one proceeding to the secondary suction. With exception to the fresh air of the backside volume Vac, it is all contained in the washing volume Vlavaggio.

The diagram in the position of FIG. 6 emphasizes only the continuation of the secondary suction, and a variation of the position of the second piston S2, thermodynamically not relevant. The pressure in the fourth room 4C reaches the greatest value because of the greatest expansion of the volume of expansion Ves and the development of the increment volume in the backside volume Vac. The pressure in the volume of expansion Ves can come down under the atmospheric due to the inertia of the gas.

The diagram in the position of FIG. 7 with special reference also to a point A, emphasizes the phase of washing of the burned gas. The pressure in the washing volume Vlavaggio comes down rapidly to atmospheric values, creating a transitory light overpressure in the fifth room 5C until the pressures of the fifth room 5C and the restrained washing volume Vlavaggio lead themselves to the same value at point A, which however it is carried out with a rapid transitory passage. In this phase all of the volumes are connected with each other and therefore identical pressure is present, with exception to the backside volume Vac that continues, thanks to its expansion, to maintain a depression.

The diagram in the position of FIG. 8 emphasizes the proceeding of the secondary suction in the backside volume Vac. The exit formed by the tenth opening E closes itself from combustion room formed by the fifth room 5C and continuous the exit of the gas from the first opening 1a, due to the push of the third piston S3 created from the expansion of the backside volume Vac. The pressure in the inside volume, with the only exclusion of the backside volume Vac, by the effect of the opening of the discharging chamber or channel formed by the first outside opening 1a, it is maintained near atmospheric values.

The diagram in the position of FIG. 9 emphasizes the continuation of the outgoing air from the first outside opening 1a due to the expansion of the backside volume Vac, while the valve formed by the sixth opening 6a is closed, determining the formation of a closed volume (Vcomp);

The diagram in the position of FIG. 10 emphasizes the beginning of the compression of the gas in the compression volume Vcomp, by means of the second piston S2. This compression produces two different thermodynamics evolutions of the gas at point A′: a part of the compression volume Vcomp is compressed and the remaining part of the inside volumes of the engine 1, with exclusion of the backside volume Vac, remains at environment pressure due to the presence of the first outside opening 1a. In this phase, the cycle has three different factors that describe the course of the pressures in the backside volume (Vac) and in the volume of the fifth room 5C that is coinciding with the compression volume Vcomp, and the primary volume Vprimar that is the remaining volume of the engine 1. The pressure in the compression volume Vcomp, from the environmental value, begins to ascend because of the decreasing of the actual volume, giving rise to its compression stroke. The pressure in the primary volume Vprimar, due to the greater expansion of the backside volume Vac with respect to the compression volume Vcomp, remains superior to the atmospheric one provoking the continuation of the leakage of air from the discharging passage forming the first outside opening 1a.

The diagram in the position of FIG. 11 emphasizes the exhaustion of the phase of outgoing air from the first outside opening 1a and simultaneously of the secondary inlet stroke, while the compression of the gas in the compression volume Vcomp begins to raise the value of the pressure.

The diagram in the position of FIG. 12 emphasizes the depression created in the primary volume Vprimar from the decreasing of the compression volume Vcomp that begins the leading inlet stroke, starting from values of pressure close to atmospheric ones, while the exit conduct being opened to the first outside opening 1a it is arranged to become the driver of suction. The backside volume Vac arrives at the greatest expansion and the pressure to its inside remains of inferior value.

The diagram in the position of FIG. 13, with reference also to the point B, emphasizes the merging of the backside and primary volumes Vac and Vprimar creating the primary inside volume Vaspprimar of the inhaled air, with pressures and temperatures that bring themselves into line. Because of the reduction of the volume of the compression volume Vcomp, the volume Vaspprimar of the inhaled air stretches out to have an inferior pressure to the atmospheric one, recalling air from the channel formed by the first opening 1a across the first conduct L1, while a complementary or alternated driver of suction via ninth opening 9a can cooperate for a more efficient inlet stroke.

The diagram in the position of FIG. 14 emphasizes the continuation of the leading inlet stroke that maintains the primary inside volume Vaspprimar of the engine 1 with inferior values of pressure to the atmospheric one, while the mark of the pressure in the compression volume Vcomp raises to the values of those to the final versions, for the vicinity of the entire confinement of the fluid in the combustion chamber.

The diagram in the position of FIG. 15 emphasizes the fact that all of the restrained fluid in the compression volume Vcomp is confined in the combustion chamber formed by the fifth room 5C. In this phase the combustion is started, by means of the spark plug C. The pressure in the fifth room 5C increases rapidly because of the phase of combustion that just started, while the channel formed by the first outside opening 1a is closed. The leading volume of suction corresponding to the primary inside volume Vaspprimar reaches the greatest expansion extending itself in all of the inside volume Vi and the pressure is carried to atmospheric values. In this phase it is made possible the exploitation of the inertia of the entry gas to obtain a small overpressure supply.

The diagram in the position of FIG. 16 emphasizes the opening of the valve forming the sixth opening 6a and the closing of the valve forming the eighth opening 8a to arrange the engine 1 to for a new initial phase of the cycle, according to the condition of FIG. 2. The pressure in the combustion room ascends rapidly because of the combustion, giving direction to the motion of the first piston S1 that constitutes the useful phase of the engine.

As already specified, the thermodynamic cycle of the internal combustion engine until now described, with the aid of FIGS. 1 to 16 and with the diagrams of the FIGS. 17 to 20, it is especially feasible with the type of rotary engine with a double center rotation already described in patent WO2004/020791, naturally with contribution of timely adaptations to its structure, as better described in the FIGS. from 21 to 31.

In stated FIGS. from 21 to 31 are shown the same building elements of the engine being object of the patent application WO2004/020791, as specified bellow in the present description showing:

a stator A; a first rotating expansion element B1 forming a rotor; a second rotating compression element B2; a third linear rotating element B3 of hinging between the rotating elements B1 and B2 forming a slider; an unloading chamber, flare or outlet hole formed as inside opening 11 of burned gas; a suction passage 25 from the sides A2*, A3*; a hub 63 of a rotor formed by first rotating expansion element B1; a seat 68 in the rotor B1 for the flow of the linear rotating element B3; a lever, rod or stem 70 of the linear element B3; and a discharged valve 90 of the burned gas corresponding to valve L of FIGS. 1 to 15. In the succession of the FIGS. 21 to 29 the points are individualized for the varied operating volumes in the individual phases of the cycle in examination beyond their variations of volume and pressure, like already described with the FIGS. from 1 to 16 and with the diagrams from FIGS. 17 to 20, such variations of volume constituting the succession of the phases of the cycle until now described and the rotary engine 1 with a double rotation center as specified above.

Particularly, they have the following correspondences:

FIG. 21 corresponds to the situation indicated in FIG. 2.

FIG. 22 corresponds to the situation indicated in FIG. 3.

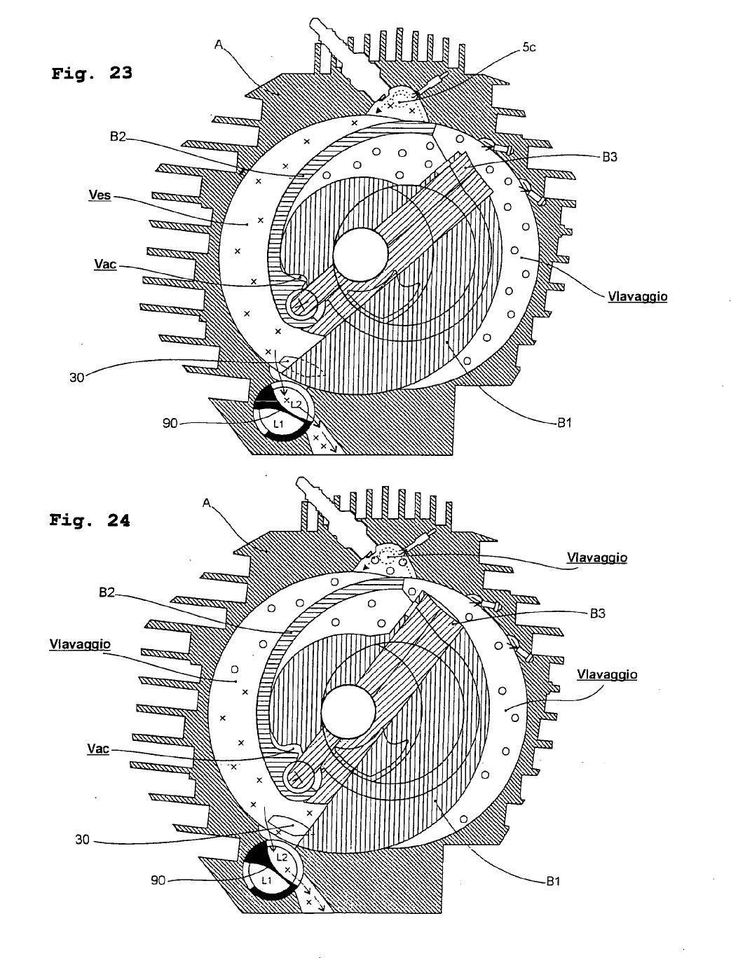

FIG. 23 corresponds to the situation indicated in FIG. 5.

FIG. 24 corresponds to the situation indicated in FIG. 7.

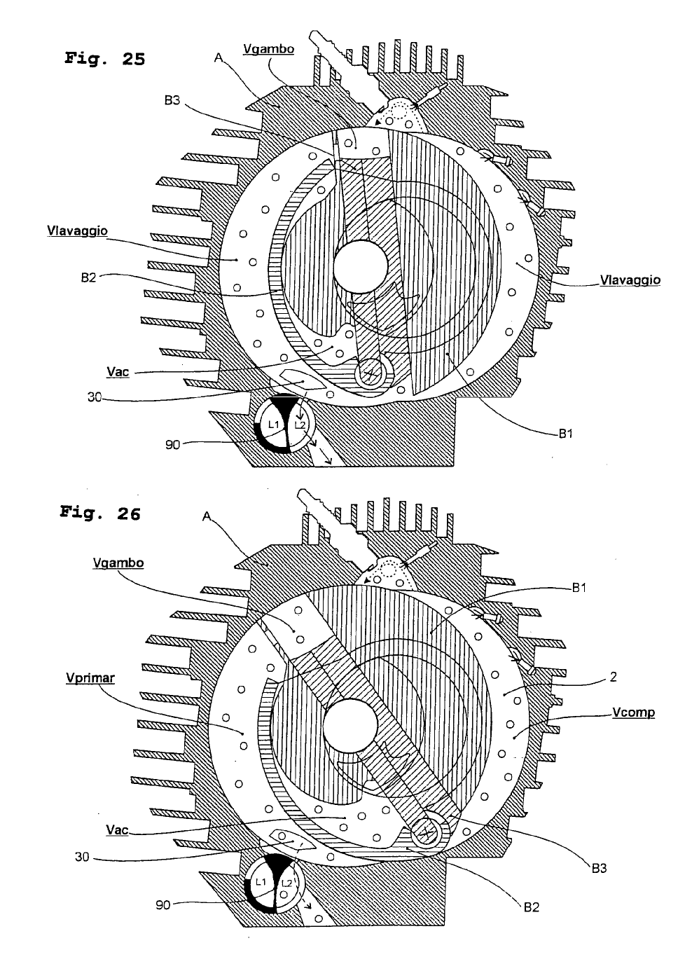

FIG. 25 corresponds to the situation indicated in FIG. 8.

FIG. 26 corresponds to the situation indicated in FIG. 10.

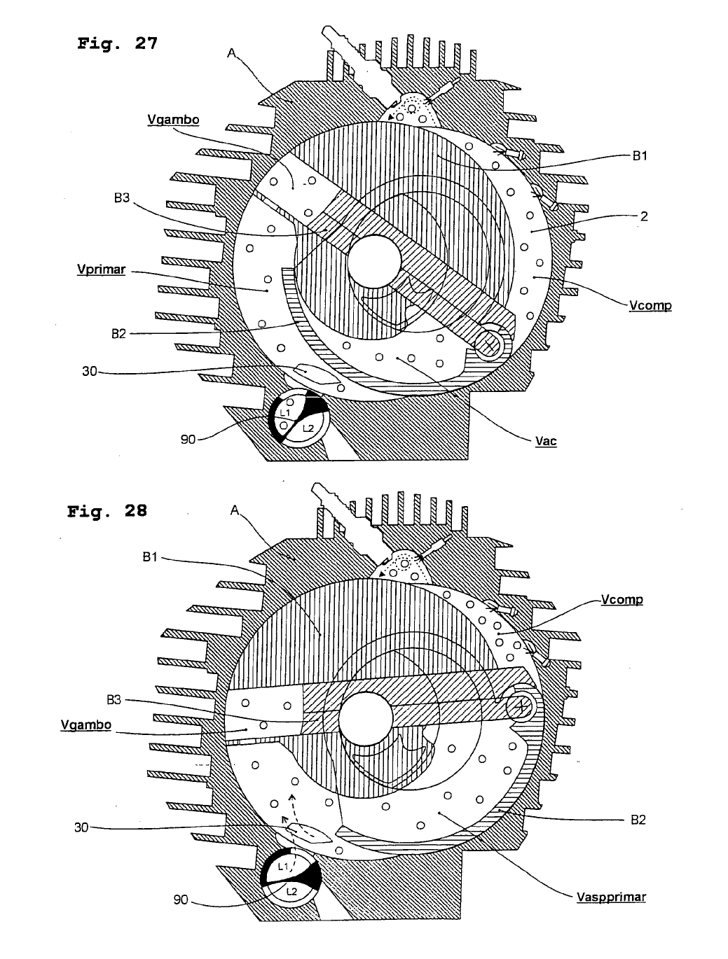

FIG. 27 corresponds to the situation indicated in FIG. 12.

FIG. 28 corresponds to the situation indicated in FIGS. 13-14.

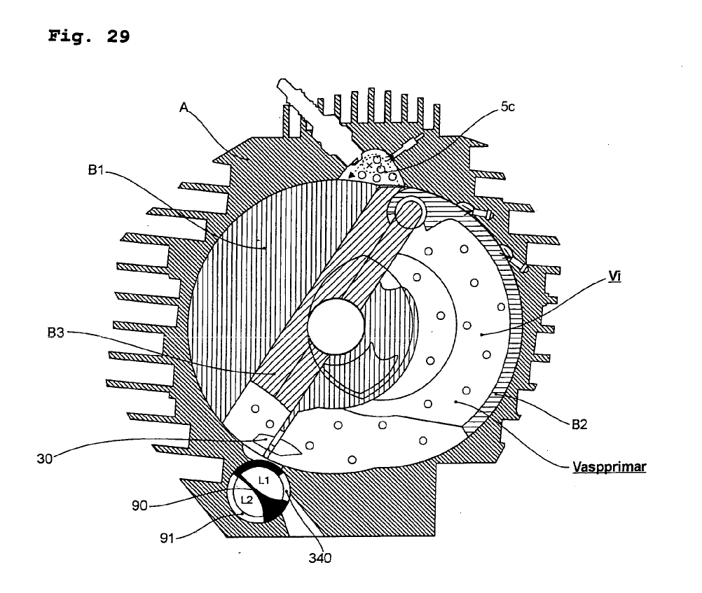

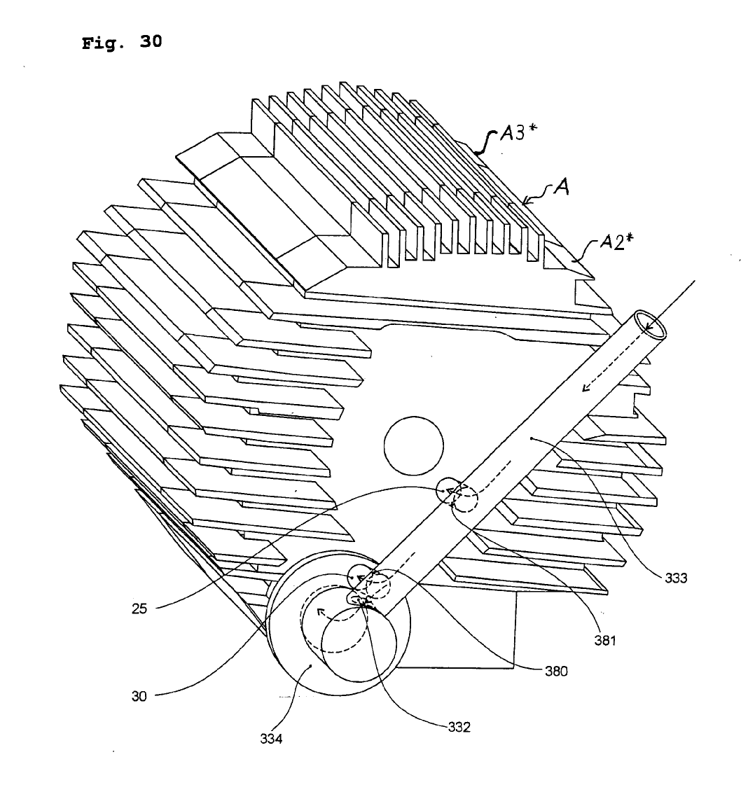

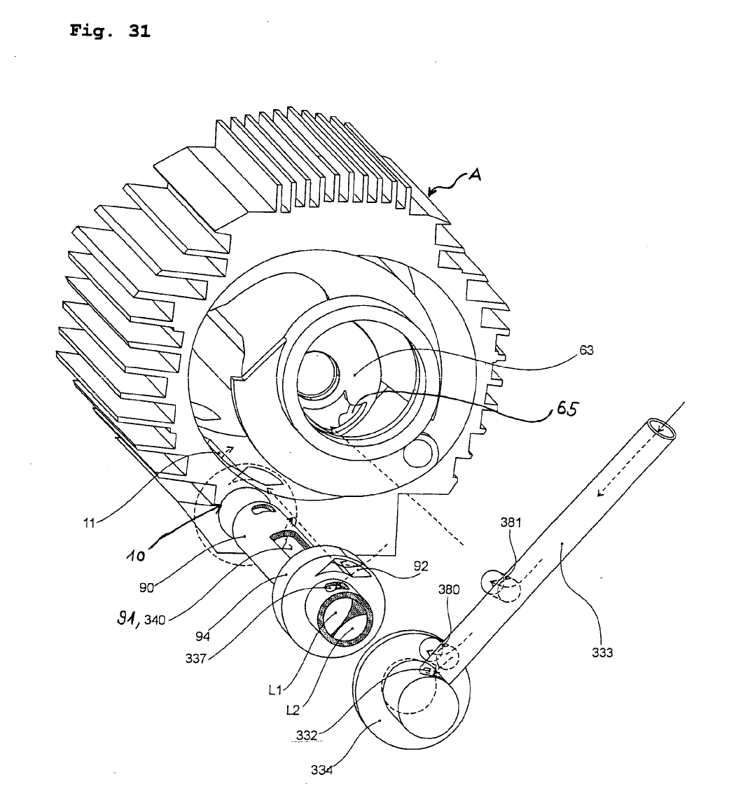

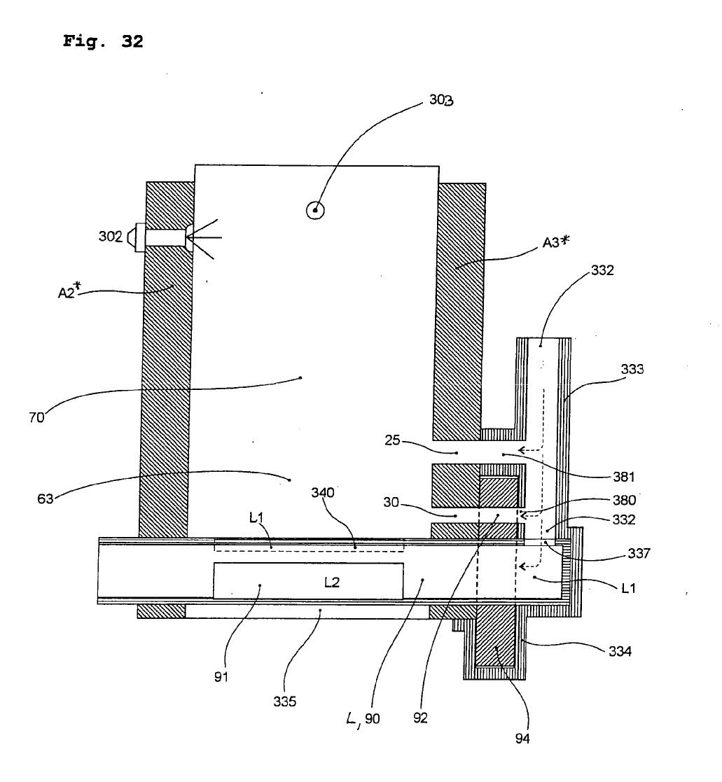

FIG. 29 corresponds to the situation indicated in FIGS. 15-16, and therefore to the initial situation of FIG. 21.

With respect to the solution that is of WO 2004/020791, the engine 1 of the FIGS. from 21 to 31 presents substantially some alterations to optimize the cycle until now described, which will be further summarized.

With reference to FIG. 27, the leading suction begins substantially from the union of the primary and backside volumes Vprimar, Vac, producing the primary inside volume Vaspprimar.

The same leading suction is made possible in two manners:

1) from the valve L already defined and marked by 90 in FIGS. 16 to 33; and

2) from an opening 30 present on sides A2* and A3* of the stator A.

1) Leading suction from the valve 90:

With special reference to the FIGS. 30 to 33, it is evident that across the valve 90, it is possible, besides the exhaust stroke of the burned gas, to also have an innovative inlet stroke, through means of a pipe or channel 333, while the same valve 90 is subdivided lengthwise in two conducts: the first conduct L1 for the suction of the outside air and the second conduct L2 for the discharging of the burned gas.

The valve 90 has substantially the same outside diameter of a shaft hole 10 of the stator A that incorporates and pivots it, while an angular breadth of the first and second conducts L1, L2 is done in connection with the breadth of valve openings 91 and 340 of the stem valve 90, beyond that to the times planned for the inlet strokes and the discharging. Especially, the hole 10 of the stator A leads in a wall of the stator A parallel to the room having inserted the rotating elements B1-B3.

Innovatively, the valve 90 also includes the valve opening 340 that is fit to develop the function of suction in cooperation with its channel forming the first conduct L1.

The inside opening 11 of the stator A, communicating between the shaft hole 10 and the inside volume to the stator A, allows the connection with the pipe of suction forming the first conduct L1 with the pipe of the discharging forming the second conduct L2 of the valve 90 to stem, that comes in rotation in its seat formed by the shaft hole 10 in phase with the developed rotor from the rotating elements B1, B2, B3.

A radial discharging opening 335 is realized on the stator A for an innovative direct expulsion of the burned gas, being arranged with its axis substantially in the middle circumference of the expansion room forming the first room with volume of expansion Ves of FIG. 23.

A further alteration of the valve 90 is given from the presence of its extension on one or both the sides of the stator A, to be able to extract from a shaft opening 337 that is communicating with a cavity 332 of the pipe or channel 333, specifically indicated in the FIGS. 30-31 and 32, and being contained with a casing 334.

2) Leading suction from the sides of the shaft and/or stator:

A further fresh entrance of air, already described as such in WO 2004/020791 in a position showing opening 92 in function of the auxiliary discharging, corresponds to the entrance formed by the ninth opening 9a of the two-dimensional diagram of FIG. 1. This opening 92 is arranged in the valve besides the opening 30 in the stator side A3*.

With special reference to FIG. 32, the main pipe of suction or channel 333 is connected to the hole or opening 92 of the valve element 94 and therefore to the pipe-like opening 30 of the sides A2, A3. The air passing from the pipe-like opening 30 is inhaled and collected in the primary inside volume Vaspprimar, as is represented in FIGS. 13 and 28.

From the FIGS. 30, 31, and 32 the accomplishment of the phase of the rotor B and the secondary suction is already emphasized in the FIGS. 4 to 12 and 23 to 27. With reference to the FIGS. 30 to 32, the closing of the pipe-like further opening 25 of the sides A2, A3 is regulated from the side surfaces of the hub 63 of the rotor formed by the first rotating element B1. A diversion 381 of the suction pipe channel 333 feeds the volume if the secondary air of the backside volume Vac through the further opening 25 formed in side A3* as specified above.

The sketch opening of the valve corresponds to the fourth opening 4a that allows the union of the primary and backside volumes Vprimar, Vac, as indicated from the passage from the FIGS. 12 to 13, corresponds to the situation of passage between the FIGS. 27 and 28 and it concludes the formation of the primary inside volume Vapprimar when the rotor formed by the first rotating element B1 is led to about 220° from the initial phase of explosion of FIG. 21.

Like in WO 2004/020791, the further entrance valve openings 25 to the secondary room of suction especially corresponding to the third room 3C are regulated from the rotor formed by the first rotating element B1 that act as a valve. In this solution the leading suction happens from the lead formed by the further opening 25 in the side A3* that is obstructed and limited from the hub 63 of the stated rotor formed by the first rotating element B1, that should create a groove or throat 65 to the flanks of the same hub 63, determining however a route of fresh air that is inefficient beyond that of generating dead volumes to the phase suction and furthermore throwing it off balance.

Innovatively, the present solution uses the entrance forming the further opening 25 in the side A3* only for the secondary suction in the phase in which the same pipe formed by the further opening 25 is placed in direct and easy connection with the backside volume Vac, while, subsequently, the leading suction continues from the pipe forming the first conduct L1 of the valve 90. With respect to WO 2004/020791 it is closed in advance of the further opening 25 that is to say to the end of the secondary suction, always by means of the first rotating element B1 that does not require the throat 65.

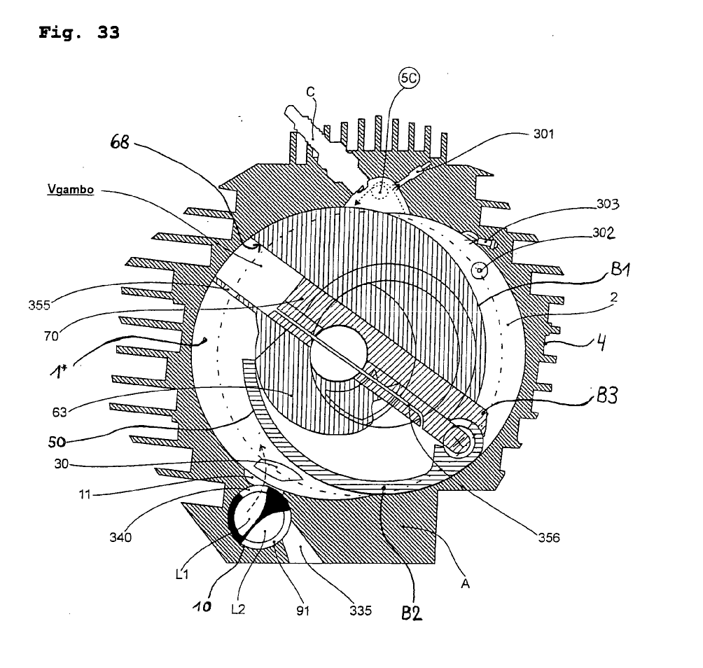

With reference to the FIGS. 27 and 33, emphasized is placed on the fact that the breadth of the conducts forming the first conduct L1 and the inside opening 30 allows an easy passage of air, limiting the necessary presence over one side, with consequent optimization of the cycle and building simplification of the engine that makes it possible.

In the succession of the phases illustrated with the FIGS. 21 to 29, it is noted that the presence of a volume especially being nameable a stem or shaft volume Vgambo that gains consistency immediately after the phase of washing, indicated from FIG. 25 and determined from the exit of the stem 70 from a seat 68, being limited from the cylindrical surface of the shaft, as such according to the solution of WO 2004/020791.

The shaft volume Vgambo is variable from the path of the stem 70 within the seat 68 and is however added to the primary volume of suction forming the primary volume Vprimar by means of a passage 355 present by the base of the same seat 68.

The presence of a passage-like pipe 356 on the stem 70 allows the communication of the shaft volume Vgambo in the chamber, flare, outlet hole or room of secondary suction forming the backside volume Vac, to eventual substitute the passage 355 as cited above.

Simply by not contributing to the inlet stroke, called shaft volume Vgambo there constitutes however an optimization and inside improvement of every space to the engine of the WO 2004/020791.

Further innovative features of the cycle in examination is that of not needing the presence of a carburator, but of to be able to introduce the carburator directly during the compression stroke, with the considerable advantages of a better dosage of the mixture, of unburned hydrocarbons of every loss of elimination from the discharging, of elimination of the problems of lubrification and of condensing of the fuel inside the engine.

This solution is made possible from the presence of an injector represented in the injector positions 301, 302, 303, and 304 of the FIGS. 21 to 29 and in FIG. 33, such a powerful injector is arranged directly in the combustion chamber formed by the fifth room 5C, or along the final part of the cylindrical surface of the compression stator chamber 2, or in the final part of the side surfaces of the same compression stator chamber 2.

With reference to FIG. 26, the compression stroke of the air resulting in the compression volume Vcomp is started from the moment that a cylindrical surface 50 of the rotor formed by the second rotating compression element B2 that enters in contact with the cylindrical surface of the compression chamber formed by the stator chamber 2, forbidding any possible air escape that is contained, having also closed the room of expansion from the first rotating expansion element B1, the beginning of the compression stroke happens which is indicative to shaft volume Vgambo having surpassed the combustion chamber formed by the fifth room 5C. This phase is indicated in FIG. 9 produced by the closing of the passages forming the sixth opening 6a and the tenth opening E.

From this position is possible to feed the injector at injector positions 301-304 to transform in mixture the air from the compression volume Vcomp.

In connection to the type of engine that needs to be realized and to the consequent unwinding of its thermodynamic cycle, the injector can be arranged in varied positions as already exemplified in the injector positions 301, 302, 303, 304, having to however suspend the injection of the fuel to the moment that the surface 50 of the rotor formed by the second rotating compression element B2 reaches and covers the injector.

To the advantage the injector, in the injector positions 302, 303, and 304 outside the fifth room 5C does not work at elevated pressures, like in the present engines with direct injection, as they do not work to low pressures, like in the present injectors with indirect injection, which at present are placed in the conducts of suction and work with pressures at atmospheric values.

The injector, in these injector positions 302, 303, and 304 outside the fifth room 5C can work in middle pressures, working to introduce the combustible over the compression volume Vcomp the value of which not yet to raised pressures, operating at a certain distance from the combustion room formed by the fifth room 5C, with consequent protection against the its high temperature and pressure values.

Naturally disposing the injector in the injector position 301 within the fifth room 5C being the combustion chamber it will be necessary to operate with an injector of high pressure and temperature, as technical noted. To favour the better uniformity of distribution of the fuel that should form the gas mixture, the other injector positions 302, 303, 304 is preferable for them to have their axis tangential to board to the middle circumference of the compression chamber formed by the fifth room 5C, namely with the cavity placed towards the combustion chamber, as exemplified in the varied figures cited, so like the injector at an injector positions 302 that are applied to the surfaces of the shaft corresponding to the rod like component A2 of second piston S2 or corresponding to the rod like component A3 of the third piston S3.

Also in the case of the application of the injector at the injector position 301 in the combustion chamber formed by the fifth room 5C, the efficiency of atomisation and distribution is dependant of the injector on the wide air entrance in the compression chamber formed by the fifth room 5C and the displacement of the spark plug C on the expansion side of the fifth room 5C. This allows for the mixture that enters in the expansion room to be reached first from the flame, entering in the already completely burned room of expansion.

The yield of the cycle until now described and illustrated is naturally influenced from a lot of parameters including: the shape of the combustion room, the compression ratio, the transmission of heat to and from the walls, the losses of load in the conducts and for the pumping of the fluid, the mechanical losses, etc. but the parameter that mostly influence the yield is the expansion ratio. In practice, the cycle that allows the largest expansion of the profitable fluid after the phase of combustion, is what has the most elevated thermal yield.

In this thermodynamic cycle, the fact that the first room 1C, with its active volume of expansion Ves can have a considerably greater dimension to the second room 2C with its compression volume Vcomp charged with the combustion chamber formed by the fifth room 5C, bring about the optimization of the thermodynamic yield.

Naturally, with respect to the building solution of the improved engine that allows the cycle described, there are possible geometrical variations that can change the parameters of the cycle described, also in connection to specific requirements for use. For example, with respect to WO, having prolonged the exhaust stroke reduces the angular development of the rotor formed by the first rotating element B1, allowing to find space to increase the angular development of the rotor formed by the second rotating element B2. This allows a further development of the powerful volume of expansion to prolong the phase of expansion.

1. Method for providing a thermodynamic cycle of the internal combustion engine (1), with a double center of rotation, for better exploitation of the propulsion in the phase of combustion from the mixture gas, from the fact that the same phase of combustion and expansion, beyond that of to produce the greatest power request for the entire combustion, allows to contemporarily activate the succession at its chambers or channels, therefore finishing the expected inlet stroke of compression of the air for the successive cycle of combustion, particularly optimising the inlet stroke, that is realized in different times and chambers, to guarantee the necessary depression for the acquisition of the greatest volume of air, to then meet in the compression chamber, determining the especially most favorable compression ratio.

2. Method for providing a thermodynamic cycle of an internal combustion engine, in particular of rotatory type with a double center of rotation, especially according to claim 1, characterized from the fact that the cycle is able to be carried out in a rotary engine with two rotation centers in which the rotation of rotating elements (B1, B2, B3) of a rotor (B) in a stator chamber (1 and 2) of a stator (A) communicates between them and with an outside, beyond the combustion chamber forming a fifth room (5C) arranged in a timed, especially an optimally timed position of the stator (A).

3. Method as in claim 2, characterized from the fact that in this cycle the rotation of the rotating elements (B1-B2 and B3) in the stator (A) determines the formation of a chamber of leading suction forming a first room (1C) having also the function of expansion, beyond that of a compression forming a second room (2C), and of a secondary suction in a third room (3C) and of a collector forming a fourth room (4C), which are advantageously communicating between them, beyond the combustion chamber forming the fifth room (C5) and with the outside environment taking in air and combustion fluid.

4. Method as in claims 2, characterized from the fact that in this cycle the chamber of the leading suction and of expansion forming a/the first room (1C) is communicating with the combustion chamber forming the fifth room (5C), for intervention of an adjustable tenth opening (E), beyond that to be communicating with the outside environment by means of a valve (L), that is provided by a suction pipe formed as a first conduct (L1) and a discharging conduct formed as a second conduct (L2) that are interconnected in a passage forming a first outside opening (Ia) of the first room (1C).

5. Method as in claim 4, characterized from the fact that in this cycle the chamber of the leading suction and expansion formed in the first room (1C) is communicating directly with a/the collector chamber formed in a/the fourth room (4C), by means of a passage forming a seventh opening (7a) created with the same motion of the rotating elements (B1-B2-B3) in the stator (A) that also determines their function as a first piston (S1) in the chamber forming the first room (1C).

6. Method as in claims 4, characterized from the fact that in this cycle the chamber of the leading suction and of expansion formed in the first room (1C) is indirectly communicating with the collector chamber formed in a/the fourth room (4C), by means of an inside passage (T) that is regulated from an access valve forming an eighth opening (8a).

7. Method as in any of claims 2, characterized from the fact that in this cycle a/the compression chamber forming a/the second room (2C) is communicating with the combustion chamber forming the fifth room (5C), for intervention of an adjustable passage forming an eleventh opening (1).

8. Method as in claims 2, characterized from the fact that in this cycle the compression chamber forming a second room (2C) is communicating with a collector chamber forming a fourth room (4C), by means of adjustable passages forming third to sixth openings (3a-6a) created with the motion of the rotating elements (B1-B2-B3) in the stator (A) that also determines their function as a second piston (S2) in the second room (2C).

9. Method as in any of claims 2, characterized from the fact that in this cycle a secondary room of suction forming a/the third room (3C) is communicating with the outside environment by means of a passage forming a second opening (2a) and is communicating with the collector chamber forming a/the fourth room (4C) by means of inside passages forming a fourth opening (4a) and a fifth opening (5a), created with the motion of the rotating elements (B1, B2, B3) and it also determines their function as a third piston (S3) in the third room (3C).

10. Method as in any of claims 2, characterized from the fact that in this cycle a collector chamber forming a/the fourth room (4C) is communicating with the leading room of suction and of expansion forming the first room (1C), with the compression chamber forming a/the second room (2C) and with the secondary room of suction forming a/the third room (3C), the chamber forming the fourth room (4C) having created and communicated with the fourth chamber (4C) with the rotating elements (B1, B2, B3) in the stator (A).

11. Method as in claim 10, characterized from the fact that in this cycle the collector chamber forming the fourth room (4C) is able to communicate directly with the outside environment, through the presence of a passage forming a ninth opening (9a).

12. Method for providing a thermodynamic cycle of internal combustion engine of rotatory type with double centers of rotation, as in any of claims 1, characterized from the fact that the phase of combustion of the mixture, contained in a/the fifth room (C5), follows the phase of expansion of the burned gas in a chamber forming a/the first room (1C), determining an increasing volume of expansion (Ves) that constitutes the contained volume (Vies) of the volume (V1) that meets the remaining inside volume of the engine (1), constituting a washing volume (Vlavaggio);

13. Method as in claim 12, characterized from the fact that during the phase of expansion of the volume of expansion (Ves) there begins a secondary inlet stroke with a formation of a backside volume (Vac) increasing the pressure in the washing volume (Vlavaggio) until up to the beginning of an exhaust stroke of the burned gas.

14. Method as in claims 12, characterized from the fact that, continuing the exhaust stroke, a/the eleventh passage (I) at the fifth room (C5) is opened that determines the communication between all the chambers insides, with exclusion of the chamber forming the backside volume (Vac), forming a sole chamber being the washing volume (Vlavaggio) that obtains the entire leakage of the burned gas from the engine (1), by means of a/the pipe formed by a second conduct (L2) of a/the valve (90).

15. Method as in any of claims 11, characterized from the fact that, while continuous opening of a/the pipe formed by a second conduct (L2) of a valve (L; 90) and increasing a/the backside volume (Vac) of a secondary suction, the conclusion of a/the phase of washing is started and a cooling of the chamber is started.

16. Method as in any of claims 11, characterized from the fact that, with conclusion of a/the phase of washing and therefore the closing of a/the pipe formed by a second conduct (L2), a compression stroke forming a compression volume (Vcomp) it is started, while a/the secondary inlet stroke forming a/the backside volume (Vac) is continuous.

17. Method as in any of claims 11, characterized from the fact that, when a/the backside volume (Vac) reaches its greatest expansion to get ready to merges itself with a primary volume (Vprimar), to form a primary inside volume (Vaspprimar) that is increased from the conducts of suction (L1, 30), because of a developed depression from a/the decreasing of a/the compression volume (Vcomp).

18. Method as in claim 17, characterized from the fact that, with the achievement of the greatest air pressure, the compression volume (Vcomp) is annulled, being the same air completely confined in the room of explosion forming a/the fifth room (5C), conveniently having mixed with the fuel introduced from injectors, for its phase of combustion.

19. Method for providing the thermodynamic cycle of the internal combustion engine, particularly of rotatory type with a double center of rotation, as in any of claims 1, characterized from the fact that a/the a second conduct (L2) of a/the valve (L;
90) remains open for the greater time of discharging, to avoid every overpressure in the initial phase leading suction to form a/the primary inside volume (Vaspprimar).

20. Thermodynamic rotatory engine with a double rotation center, for performing the method as in claims from 1, characterized from the fact of being perfected especially in the suction elements forming a/the a first conduct (L1) and of discharging forming a/the a second conduct (L2) on the valve (90), on the pipe of discharging (335) and on the variation of the function of the pipe of alimentation (30) of the stator (TO).

21. Thermodynamic engine as in claim 20, characterized from the fact that a shaft volume (Vgambo) is put in communication with resting primary and backside volumes (Vprimar, Vac), from an opening (355) within a seat (68) of a/the rotor (B) or from a pipe (356) on a stem (70) of the seat (68).

22. Thermodynamic engine as in claim 20, characterized from the fact that in a/the compression chamber forming a/the second room (2) an injector of the fuel, beyond that of a specific position (301) in a/the combustion chamber forming a/the fifth room (5C), can be alternately applied in the especially optional time position (302-303) of its cylindrical surface or on the side (304) for its protection from the temperature and from a compression pressure of the compression chamber.
